(19) United States
(12) Patent Application Publication
(10) Pub. No.: US 2023/0061115 A1
(43) Pub. Date: Mar. 2, 2023

(54) CENTRIFUGALLY MOTIVATED FLUIDIC SYSTEMS, DEVICES AND METHODS

(71) Applicant: ODx Innovations Limited, Inverness (GB)

(72) Inventors: Seoirsse MURRAY, Melbourn (GB); Richard JANSE VAN RENSBURG, Melbourn (GB); James IZZARD, Melbourn (GB); Steve GRIMWADE, Melbourn (GB); Piers HARDING, Melbourn (GB); Ewan CHIRNSIDE, Inverness (GB); Mike MALECHA, Inverness (GB)

(21) Appl. No.: 17/796,573

(22) PCT Filed: Feb. 1, 2021
(86) PCT No.: PCT/GB2021/050221

§ 371 Date: Jul. 29, 2022

(30) Foreign Application Priority Data
Jan. 31, 2020 (GB) 2001399.1

(51) Int. Cl. B01L 3/00

(52) U.S. Cl. CPC B01L 3/502738; B01L 2200/025; B01L 2200/0684; B01L 2300/021; B01L 2300/042; B01L 2300/0672; B01L 2300/0681; B01L 2300/0864

(57) ABSTRACT

A fluidic device (1) configured to drive movement of fluid under centrifugal force comprises a central region about a central rotational axis (X) of the device and a peripheral region extending radially outwards from the central region. A fluid reservoir (4) provided in the central region of the device receives a fluid sample and communicates with at least one fluidic system (6), which extends radially outwards from the fluid reservoir (4) into the peripheral region of the device. Each fluidic system (6) comprises a fluid analysis chamber (12) configured to retain a portion of a fluid sample for analysis. A fluidic channel arrangement (26) is configured to enable fluid communication between the fluid reservoir (4) and the fluid analysis chamber (12), and movement of the fluid sample through the fluidic channel arrangement is driven by the centrifugal force created by rotational motion of the device about the central rotational axis (X). A valve mechanism (8) is arranged between the fluid reservoir (4) and the analysis chamber (12) and is configured to prevent fluid flow through that portion of the fluidic channel arrangement (26) when the speed of rotation of the device is less than a predetermined value. A cut-out portion of the device (24) may help to correctly locate the fluidic device (1) within an assay apparatus. An apparatus for driving rotational motion of the fluidic device and a method for moving a fluid sample within the fluidic device are also described.

### TECHNICAL FIELD

The present disclosure relates to containers and devices comprising centrifugally motivated fluidic systems, and particularly to the uses of such containers and devices to distribute portions of a fluid sample and the subsequent analysis of sample properties.

### BACKGROUND

Fluidic systems are closed, interconnected networks or structures comprising channels and chambers or reservoirs and having dimensions in the millimetre to micron range.

Flow of fluid through the interconnected network of channels and chambers in the fluidic system can be driven or motivated using centrifugal/centripetal forces that are generated via rotation of the device or platform in which the fluidic system is formed.

This concept of centripetally motivating or driving flow of fluid through fluidic systems via rotation, is used in a variety of devices and is applicable over a wide range of technical fields. There are several different devices which utilise such concepts in relation to chemical and/or biological assay technology; in such cases, analyses of properties of the fluid are generally carried out either during or after such movement.

It is against this background that the present devices, systems and methods have been devised.

### SUMMARY OF THE DISCLOSURE

According to an aspect of the disclosure, there is provided a fluidic device configured to drive movement of fluid under centrifugal force, the fluidic device comprising: a central region about a central rotational axis of the device and a peripheral region extending radially outwards from the central region; a fluid reservoir provided in the central region of the device for receiving a fluid sample, the fluid reservoir in communication with at least one fluidic system, the at least one fluidic system extending radially outwards from the fluid reservoir into the peripheral region of the device; the or each fluidic system comprising: a fluid analysis chamber configured to retain a portion of a fluid sample for analysis; a fluidic channel arrangement configured to enable fluid communication between the fluid reservoir and the fluid analysis chamber, wherein movement of the fluid sample through the fluidic channel arrangement is driven by centrifugal force arising from rotational motion of the device about the central rotational axis; and a first valve mechanism configured to prevent fluid flow through a portion of the fluidic channel arrangement when the speed of rotation of the device is less than a first predetermined value, wherein the first valve mechanism is arranged between the fluid reservoir and the analysis chamber. In any aspects and embodiments, the valve mechanism may advantageously be a pneumatic gate or ‘air spring’.

Suitably, in such aspects and embodiments, the fluidic channel arrangement comprises: a separation chamber configured to remove unwanted particles from the fluid sample prior to the fluid sample entering the analysis chamber; and a first fluidic channel extending radially outwardly from the fluid reservoir to the separation chamber. Preferably, wherein the first fluidic channel arrangement communicates with the separation chamber through a wall in a radially outer region of the separation chamber.

In some embodiments, the first fluidic channel extends to a radially outermost portion of the at least one fluidic system. In other embodiments, the separation chamber is shaped such that it encompasses a radially outermost point of the fluidics system. In other particularly suitable embodiments, the fluid analysis chamber is arranged radially outwards of the separation chamber. Most suitably, the fluid analysis chamber is the radially outermost element of the fluidic system. In embodiments, the fluid analysis chamber is cylindrical having a substantially circular cross section in an axial plane of the device.

The separation chamber may be configured/shaped to define a pocket, ‘toe’ or corner that extends radially outwards of the inlet for the first fluidic channel. Beneficially, in such arrangements, incoming non-clarified fluid does not disturb any sediment stored/collected in the radially outermost portion of the separation chamber. In some embodiments the separation chamber is wedged-shaped wherein a relatively wide region of the separation chamber is orientated radially outwards of a relatively narrow region of the separation chamber. This may further assist sediment to settle further from the inlet of the first fluidic channel.

In some embodiments, the separation chamber has a depth (d) defining the height between a base of the separation chamber and the top of the separation chamber, and the first fluidic channel is arranged to communicate with the separation chamber at or proximate the base of the separation chamber, such that the separation chamber is charged with fluid sample from the base upwards.

Suitably, the fluidic channel arrangement comprises a second fluidic channel configured for fluid communication between the separation chamber and the fluid analysis chamber, and wherein the first valve mechanism is located in the flow path of the second fluidic channel between the separation chamber and the analysis chamber. In such embodiments, the second fluidic channel may suitably comprise a pair of channel arms configured to enable fluid flow in substantially antiparallel directions (e.g. the first and second channel arms may both be arranged to extend in a generally radial orientation), and wherein the first valve mechanism is located in the flow path between the two channel arms. Thus, the second fluidic channel may comprise a first channel arm for fluid communication between the separation chamber and the first valve mechanism, the first channel arm extending radially inwardly from the separation chamber to the first valve mechanism and communicating with the separation chamber through a wall in a radially inner region of the separation chamber. Advantageously, therefore, the first fluidic channel communicates with the separation chamber radially outwards of the first channel arm of the second fluidic channel, so that non-clarified fluid entering the separation chamber may be clarified before it exits the separation chamber in the direction of the valve mechanism.

Beneficially, a weir (or step) is located between/at the junction of the separation chamber and the entry port of the second fluidic channel. The weir may improve the separation/clarification functionality provided by the separation chamber, by retaining the fluid sample in the separation chamber for a period of time while clarification takes place. A weir may also inhibit particles in the fluid from passing freely into the second fluidic channel. The height of the weir or step may be step depending on preferences and the desired functionality.

Furthermore, in embodiments, the second fluidic channel comprises a second channel arm for fluid communication between the first valve mechanism and the analysis chamber, the second channel arm extending radially outwardly from the first valve mechanism to the analysis chamber.

Beneficially, according to these aspects and embodiments, the first valve mechanism is located radially inwardly of the separation chamber and/or the fluid analysis chamber.

In embodiments of the present disclosure, the first valve mechanism defines a chamber for receiving a predetermined quantity of gas, the chamber having dimensions in x, y and z axes, wherein the x axis defines a radial direction, the y axis defines a direction perpendicular to the x axis in a radial plane, and the z axis defines a direction perpendicular to both the x and y axes parallel to the axis of rotation. In some preferred embodiments, the first valve mechanism has a largest dimension in the z axis (i.e. the maximum dimension of the chamber in the z-axis direction is longer than the maximum dimension in both the x-axis dimension and the y-axis dimension. By being configured such that the largest dimension of the valve mechanism is in the direction of the axis of rotation, the radial dimension of the fluidic device may beneficially be reduced (e.g. by a reduction in the maximum x-axis dimension of the first valve mechanism); and/or the fluidic device may preferably be able to comprise a greater number of fluidic systems arranged circumferentially about the device (e.g. by a reduction in the maximum y-axis dimension of the first valve mechanism). Beneficially, the first valve mechanism is arranged circumferentially around, radially outwards of and adjacent the fluid reservoir. Typically, the first valve mechanism defines a chamber having a volume in the range of about 150 to 600 μl. In any such embodiment, the volume of the analysis chamber may be in the range of about 30 to 150 μl. In some such embodiments, the volume of the sedimentation chamber may be in the range of about 60 to 300 μl. Thus, according to aspects and embodiments of the disclosure, the volume of the sedimentation chamber is suitably about 2 times the volume of the analysis chamber, and the volume of the air spring is suitably in the range of about 2 to 4 times the volume of the sedimentation chamber. Beneficially, in connection with the present embodiments, the volume of the air spring/valve mechanism may be in the range of about 150 to 600 μl; and/or the volume of the analysis chamber may be in the range of about 30 to 150 μl, and/or the volume of the sedimentation chamber may be in the range of about 60 to 300 μl.

Particularly for use in determining bacterial sensitivity to one or more antibiotics, one or more of the fluidics systems contains, in a region thereof, at least one antibiotic in a form suitable for dissolution in the fluid sample. Beneficially, the antibiotic is in dried form. In embodiments, the antibiotic is dried and reversibly adhered to the analysis chamber of the device. In some embodiments a drug or other additive/chemical other than an antibiotic, in a form suitable for dissolution in a fluid sample, may be contained in one or more of the fluidics systems of a device according to the disclosure. Suitably, the one or more antibiotic, drug or chemical may be selected according to fluid sample, the infectious/disease agents expected to be present or the property of the sample or disease agent to be assessed.

In some embodiments, the fluidic channel arrangement further comprises a third fluidic channel extending between the fluid analysis chamber and a second valve mechanism, and wherein the second valve mechanism is located radially inwardly of the analysis chamber. Suitably, the first and/or the second valve mechanism each comprises a storage chamber containing a (compressed) gas. In some such embodiments, the second valve mechanism defines a chamber having a volume in the range of 10 to 50 μl. Generally, therefore, the volume of the second valve mechanism, where present, is less than (e.g. between 3 and 15 times less than) the volume of the first valve mechanism.

In use, fluid within the fluidics systems of the device are subject to a combination of forces, including centrifugal force, gas pressure, and wicking/capillary forces as a result of the fluid moving through the relatively narrow fluidics channels and in particular the very small (e.g. less than 100 μm) regions at the interfaces of the fluidics channels and the channel covers and base, which may act counter the centrifugal and other forces. In order to reduce any such undesirable fluid movement, one or more fluidic channel of the at least one fluidic system may be configured with rounded internal corners, in order to reduce capillary forces within the fluidics system. In particular, at least the fluidics channel between the fluid analysis chamber and the first valve mechanism (or second channel arm of the second fluidics channel) may have rounded internal corners. Similarly, the fluidics channel between the first valve mechanism and the separation chamber (or first channel arm of the second fluidics channel) may have rounded corners. According to such aspects and embodiments of this disclosure, a rounded internal corner may have a radius of curvature of from approx. 0.05 to 1 mm, such as 0.1 to 0.8 mm or 0.2 to 0.6 mm (e.g. approx. 0.6 mm or less).

Suitably, at least one fluidics system of the device contains at least one drug to be assayed against the fluid sample, wherein the drug is provided in the fluid analysis chamber; in a first drug retention chamber located between the first valve mechanism and the fluid analysis chamber; or in a second drug retention chamber located between the second valve mechanism and the fluid analysis chamber. The drug may be an antibiotic. Suitably the drug is lyophilised and/or freeze-dried.

It will be appreciated that any one or more antibiotic may be incorporated into the fluidic device according to the invention. In various aspects and embodiments, the skilled person may select one or more antibiotic and one or more concentration of the one or more antibiotic for use in the system according to preferences: for example, depending on the infectious agent that is expected to be present or based on the fluid sample to be used in conjunction with the fluidics device. In particular embodiments, the drug/antibiotic may be selected from one or more of the group comprising/consisting of: Ciproflaxacin HCl monohydrate (CIP); Phosphomycin Disodium Salt (FOS); Mecilinam Hydrochloride (MEC HCl); Nitrofurantoin Sodium (NIT); Trimethoprim Lactate (TMP); and Sulfamethaxazole Sodium (SXT). In other embodiments, the drug/antibiotic is selected from one or more of the group comprising/consisting of: Amoxicillin; Amoxicillin/clavulanic acid (2/1); Cefalexin; Ciprofloxacin; Ertapenem; Fosfomycin; Levofloxacin; Mecillinam; Nitrofurantoin; Trimethoprim; and Trimethoprim/sulfamethoxazole (1/19). More particularly: at least one fluidic system contains the antibiotic Amoxicillin; at least one fluidic system contains the antibiotic combination Amoxicillin/clavulanic acid; at least one fluidic system contains the antibiotic Cefalexin; at least one fluidic system containing the antibiotic Ciprofloxacin; at least one fluidic system containing the antibiotic Ertapenem; at least one fluidic system containing the antibiotic Fosfomycin; at least one fluidic system containing the antibiotic Levofloxacin; at least one fluidic system containing the antibiotic Mecillinam; at least one fluidic system containing the antibiotic Nitrofurantoin; at least one fluidic system containing the antibiotic Trimethoprim; and/or at least one fluidic system containing the antibiotic combination Trimethoprim/sulfamethoxazole; and optionally: at least one fluidic system that doesn't contain an antibiotic and/or at least one fluidic system that contains an effective amount of a bactericidal agent. In some embodiments, the device comprises a plurality of different antibiotics, such as selected from the antibiotics disclosed herein. In some embodiments, the device may comprise 2, 3, 4, 5 or 6 antibiotics or antibiotic combinations deposited in different ones of the plurality of microfluidics systems. In some embodiments, the device comprises each of the above antibiotics. Suitably, the antibiotics or other drug(s)/chemical(s) are provided in dried form or another form suitable to aid with dissolution of the agent in the sample solution.

In accordance with aspects and embodiments of the invention, a plurality of fluidic systems of a device of this disclosure contain one of the antibiotics or antibiotic combinations (or other agent), and each microsystem of the plurality of microsystems contains a different predetermined quantity of the antibiotic or antibiotic combination such that, in use, a predetermined different concentration of the antibiotic (or other agent) is generated in a fluid sample within each analysis chamber respectively of the plurality of fluidic systems. Preferred devices according to the present disclosure comprise one or more antibiotics in an amount selected from the antibiotics and corresponding amounts of Tables 1 and/or 2. In particular, in embodiments of the disclosure, the amount of antibiotic contained within each fluidic system is determined such that, when dissolved in the quantity of fluid sample that passes the first air spring/valve mechanism, in use, to fill the analysis chamber, the concentration of antibiotic in the fluid sample within the analysis chamber is approximately equal to a desired predetermined concentration. Suitably, the concentration of antibiotic (or antibiotic combination) is equal to the breakpoint of the respective bacteria in accordance with CLSI standards. In other embodiments, the concentration of antibiotic (or antibiotic combination) is equal to the breakpoint of the respective bacteria in accordance with EUCAST standards. In some embodiments, the antibiotic may be present in multiple separate fluidic systems at different respective amounts to achieve, in use, a desired range of different antibiotic concentrations in the final fluid samples of the multiple separate fluidic systems. For example, the desired/target antibiotic concentrations may be a multiple of the CLSI and/or EUCAST concentration (e.g. multiples of 1×, 1.5×, 2×, 3×, 4×, 5×, 6×, 8×, 10× or more). It will be appreciated that the effectiveness of the particular antibiotic or other agent may be impacted/altered by the conditions of the biological sample and/or growth media and, therefore, the effective inhibitory or bactericidal concentrations may differ from those that would be predicted by CLSI or EUCAST. Therefore, in aspects and embodiments any suitable antibiotic (or other agent) concentrations or amounts (or concentration range or amount range) may be incorporated according to preferences and desired outcomes.

Beneficially, the fluidic device comprises a bacterial growth media configured to promote growth of bacteria potentially present in the fluid sample when mixed with a fluid sample, in use. In such embodiments, the growth media provided in the fluid reservoir or in a growth media compartment that is in fluid communication with the fluid reservoir. Advantageously, in any such embodiments, the growth media is provided in a growth media compartment that is in fluid communication with the fluid reservoir via a filter element or membrane. The growth media may be in concentrated liquid form, but is advantageously in solid form or powdered form. Solid form is generally preferred and may be easier to handle during assembly of the device. For example, the media may be provided in the form of a compressed pellet or pill, or in powdered form within a dissolvable capsule. Such a capsule embodiment may be beneficial since the growth media is protected from undesirable exposure to the atmosphere/environment prior to use; but may be dissolved rapidly on contact with the biological sample once released from the capsule.

Thus, a membrane may be provided to filter the fluid sample before it enters the fluidic systems. Generally, it is beneficial to provide a filter or other membrane after the fluid sample has been mixed with growth media. A filter or other membrane device may be beneficial in preventing non-dissolved fragments of growth media and/or other relatively large contaminants that may be present in the sample from entering the fluidics system. Any appropriate membrane/filter pore size may be used, such as 100 μm, which conveniently traps salts and other particulate matter (such as non-dissolved growth media) of 100 μm and above. A convenient filter or member may be formed of a polymeric material (e.g. polypropylene) or a metal material (e.g. stainless steel). Metal filter elements are preferred in some arrangements.

The fluidic device of any embodiment may comprise a sample receiving well for receiving fluid sample before it is transferred into the fluid reservoir and subsequently into the at least one fluidic system.

In some beneficial embodiments, a central region of the fluidic device comprises a sample receiving well for receiving a fluid sample. The sample receiving well is communicable with the fluid reservoir; typically, via a growth media compartment containing a growth media and a filter element may be arranged axially between the growth media compartment and the fluid reservoir, in use, to filter the mixture of fluid sample and growth media before it enters the fluid reservoir. Advantageously, the sample receiving well, growth media compartment, filter element and fluid reservoir are arranged axially in line about a central rotational axis of the device.

In any embodiments of the device, a cap or lid may be provided for enclosing the sample receiving well. Conveniently, the sample receiving well is formed within an upstanding neck portion of the central region of the device (which is also arranged axially about a central rotational axis of the device). Suitably, the neck portion is provided with a securing feature for engagement with a complementary securing feature of the cap. In particular embodiments, the securing feature is a screw-thread. For example, the external wall of the neck portion may be provided with a male screw-thread for engagement with a complementary female screw-thread on an internal wall surface of the cap or lid.

Typically, the cap has a top/upper wall and an outer annular perimeter wall downstanding from the top wall. Conveniently, the inner surface of the outer perimeter wall may be provided with a screw-thread for engagement with the complementary screw-thread of the neck portion of the fluidic device.

Advantageously, in any embodiment of the disclosure, the cap may comprise a plug or plunger element configured to provide a sealing or friction fit with the inner surface of the sample receiving well (e.g. by way of an annular skirt or lip), such that when the cap engages with the neck of the fluidic device, the plunger displaces a predetermined volume of fluid from the sample receiving well towards the central reservoir and fluidic systems, without the fluid substantially leaking past the plunger away from the fluidic system. Thus, the cap may comprise a cylindrical plunger element downstanding from the top wall of the cap and arranged radially inside the outer annular perimeter wall. In such embodiments, the outer annular surface of the plunger element may be configured to match the inner annular surface of the sample receiving well so as to displace a predetermined volume of fluid from the sample receiving well when the cap is engaged with the neck of the fluidic device.

In alternative embodiments of the disclosure, it is not necessary for the cap to be provided with a plug or plunger element arranged to force sample fluid downwards towards the central reservoir. Rather, the sample, mixed with dissolved media, may pass through any filter/membrane arrangement arranged between the sample receiving well and the central reservoir under the action of gravity and, in use, centrifugal force, pressure changes or other forces acting on any liquid sample remaining in the sample receiving well as the device is used. This can simplify the manufacture of the device without compromising performance.

To maintain the growth media in a substantially clean or sterile environment, or otherwise to prevent the growth media being exposed to the environment before use of the device, a breakable seal element may conveniently be provided. The seal element is conveniently provided between the sample receiving well and the growth media compartment. Suitably, the seal (which can be formed of any appropriate material) is substantially impermeable to solid particles and/or liquid and/or gas. For example, the seal may be formed of a foil material or a plastics/polymeric material. Alternatively, the seal may decompose/deteriorate or dissolve in the presence of a water-based liquid, such as the biological sample. The seal element is fixed into place using any appropriate mechanism as described herein—for example, by way of an adhesive. In alternative embodiments a seal between the growth media and sample receiving well may not be provided—for example, when the growth media is otherwise protected from the environment, such as when the growth media is provided with a protective coating or is otherwise encapsuled in pellet or powdered form, e.g. in the form of a capsule or other similar pill.

In particularly beneficial embodiments, the cap comprises one or more projections arranged radially inside and downstanding from the cap. These projections are configured to pierce the seal element, where present, between the sample receiving well and the growth media compartment to allow fluid communication between the sample receiving well and the growth media compartment. As will be appreciated, piercing of the seal element allows mixing of a fluid sample held within the sample receiving well with a growth media held within the growth media chamber. In preferred embodiments, the one or more projections are arranged downstanding from the lower surface of the plunger element, where present. The one or more projections may take any effective form, such as any of the forms or configurations described herein. For example, they may take the form of fins or blades, which are capable of both piercing a seal between the growth media compartment and the sample receiving well, and to improve mixing of the fluid sample with the growth media to improve dissolution. Furthermore, in some embodiments the fins or blades may be configured to scrape the inner walls of the growth media compartment, in use, such that growth media that may be adhered to the walls of the device can more readily be solubilised.

The fluidic device of any embodiment of the present disclosure may comprise a collar element engageable between the neck of the device and the cap, and configured to limit the depth of engagement between the cap and the neck such that the cap cannot be fully engaged with the neck of the device before the user intended. For example, by preventing inadvertent full engagement between the cap and neck/body of the device, the user will not be able to unintentionally lock the cap onto the neck (where latching features are present to control reuse of or exposure to a contaminated device), and/or will not unintentionally pierce a seal element, where present, to expose the growth media to the environment (where one or more projections are provided on the underside of the cap for this purpose). In some embodiments, the collar element is formed integrally with the cap. In other embodiments, the collar element is formed separately from the cap. In some such embodiments, the collar element may be formed integrally with the outer perimeter wall of the cap and the join between the collar and cap is configured to be (manually) breakable to enable a user to remove the collar from the cap without using tools. Where the collar is formed separately from the cap, this advantageously enables the collar to be formed of a different material to the cap, which e.g. may allow for cheaper, more easily removed or more recyclable materials to be used. In some embodiments, however, the cap-limiting feature may not be a collar, but may be any other appropriate mechanism, such as a tab to prevent the cap from fully engaging with the neck of the device.

In embodiments, the fluidic device may comprise a funnel element configured to guide the fluid sample into the top of the sample receiving well.

In any embodiments, the neck portion may be formed of an outer annular wall and an inner annular wall, the inner annular wall defining at least a portion of the sample receiving well and the outer annular wall being provided with the securing feature for engagement with the complementary securing feature of the cap. In some such embodiments, space between the outer annular wall and the inner annular wall of the neck portion defines an annular chamber or may be divided into a plurality of radially segmented chambers by a plurality of radially spaced walls or ribs. Beneficially, the annular chamber or at least one of the radially segmented chambers is configured as an overflow chamber, the overflow chamber in fluid communication with the sample receiving well via at least one overflow aperture. Advantageously, the overflow aperture is arranged such that a predefined maximum volume of fluid sample can be received in the sample receiving well before the fluid sample in the sample receiving well reaches the (height of the) at least one overflow aperture. The overflow feature thus limits the amount of fluid that can be poured into the sample receiving chamber while mitigating against fluid overspill outside of the device. In embodiments, the overflow aperture is provided in a wall of the sample receiving well or in a funnel element that is configured to guide fluid sample into the top of the sample receiving well. The overflow aperture may thus communicate with an upper region of the overflow chamber. As noted, the overflow chamber helps to prevent or reduce the risk of contaminating the outside of the fluidic device, in use, by capturing excess fluid sample in one or more overflow chambers of the fluidic device which in use can be sealed from the environment, e.g. by engagement of a cap over the neck of the device.

In some embodiments, at least one of the radially segmented chambers is configured as a gas release chamber, the gas release chamber in fluid communication with the central fluid reservoir via at least one gas release aperture, the gas release aperture communicating with a lower region of the gas release chamber, and arranged such that as the fluid reservoir is filled with fluid sample from the sample receiving well, gas within the fluid reservoir may be expelled upwards into the at least one gas release chamber. Such a configuration beneficially allows air to be removed from the fluid reservoir such that the fluid reservoir can be filled with fluid sample; it may also avoid over-pressurisation of the fluid sample within the fluidic device; and may prevent a vacuum forming behind the fluid sample when it is evacuated from the central fluid reservoir and dispersed into the various fluidic systems, in use. In such embodiments, a gas/fluid release aperture may also be provided in the top surface of the neck, funnel and/or cap, to allow pressure to equalise within the device. Any such gas release orifices may preferably be covered by a hydrophobic membrane to prevent leakage of liquid sample from the device.

Conveniently, in some embodiments, the bottom surface of the plug or plunger of the cap may be provided with one or more gas release orifices which, in use, allow gas to escape from the sample receiving well and/or the central fluid reservoir, as above. Such orifices may preferably be covered by a liquid impermeable or hydrophobic membrane to prevent leakage of liquid sample from the device. Suitably, in such embodiments, a second plurality of gas release orifices is provided through the top surface of the cap (in communication with the first set of gas release orifices) to allow gas to escape to and/or pressure within the device to equalise with the atmosphere.

In various aspects and embodiments, one or more orifices may be provided in the top of the cap to provide a ‘breather’ to allow pressure to equalise between the inside of the device and the atmosphere. Such orifices may suitably be covered by a filter or membrane—preferably a hydrophobic filter or membrane to prevent fluid escaping from the sample receiving well. Such a filter or membrane suitably has a perforation diameter selected to allow pressure to equalise between the device and the atmosphere, so as to prevent pressure build-up, e.g. of approx. 0.45 μm is small enough to prevent bacteria from entering, but should not unduly restrict airflow for pressure equalisation. Such a breather may conveniently be provided in the centre of the cap in communication with the sample receiving well, such that additional or dedicated gas release chambers may not be necessary.

Typically, in embodiments of the present disclosure, the fluidic device comprises a main body and a base, wherein the fluid reservoir and the at least one fluidic system is defined within the main body of the device and exposed on the underside thereof. In such embodiments, the base is connectable with the main body to seal the fluidic system to prevent fluid leakages.

The base thus forms the lower surface or base of the central fluid reservoir and fluidic systems. Importantly, at least a portion of the base defining the lower surface of at least one fluid analysis chamber is optically transparent to light of a desired wavelength. In some such embodiments, the base is a film configured to be secured to the main body of the device by an adhesive, by heat sealing, or by any other suitable mechanism. In some beneficial embodiments an adhesive may be used; in other beneficial embodiments heat sealing is used.

In embodiments, the fluidic device may comprise an antibiotic sensitivity panel comprising a plurality of antibiotics. Suitably, the plurality of antibiotics may be used in amounts selected from one or more of the antibiotic amounts disclosed in Tables 1 or 2 or Table 3. In particular embodiments, the fluidic device suitably comprises an antibiotic sensitivity-testing panel according to the antibiotic concentrations of the CLSI standard and/or the EUCAST standard as defined in Table 3. However, in other embodiments suitable antibiotic concentrations for one or more of the selected antibiotics may be determined independently of any standard system; for example, to optimise the assay system for a particular use, such as in testing the antibiotic sensitivity of infectious agents in urinary tract infections (UTIs).

In a second aspect, there is provided an apparatus comprising: the fluidic device according to any aspect or embodiment of the present disclosure; a driving mechanism for driving rotational motion of the fluidic device about the rotational axis of the fluidic device; and a controller executing machine readable code to cause the driving mechanism to control flow of the fluid sample from the fluid reservoir to the or each analysis chamber.

In embodiments of this second aspect, the apparatus may comprise an optical apparatus, the optical apparatus comprising: a light source configured to emit an incident beam of light and illuminate the fluid sample in the or each fluid analysis chamber; and a photodetector configured to detect scattered light exiting the or each fluid analysis chamber.

Embodiments of this aspect may also comprise a sample container carousel arranged to engage the container and configured to bring the or each fluid analysis chamber periodically into and out of alignment with the incident beam of light from the light source of the optical apparatus.

Conveniently, at least one processor is configured to analyse the detected scattered light to determine one or more properties of the fluid sample contained in the or each fluid analysis chamber. Suitably, the property that is determined is selected from: a relative amount of bacteria; a relative concentration of bacteria; a change in the relative amount of bacteria as a function of time; a change in the relative concentration of bacteria as a function of time; a qualitative amount of bacteria; a qualitative concentration of bacteria; an actual amount of bacteria; a change in the relative amount of bacteria as a function of time; or an actual concentration of bacteria present in the fluid sample in the analysis chamber as a function of time.

In accordance with a third aspect, there is provided a method of moving a fluid sample from a fluid reservoir through a fluidic system formed in a fluidic device, the fluidic system comprising a fluid analysis chamber, and a fluidic channel arrangement configured to enable fluid communication between the fluid reservoir and the fluid analysis chamber, the method comprising: rotating, by a driving mechanism, the fluidic device about a rotational axis at a first rotational speed and for a first duration to generate a first centrifugal force sufficient to drive flow of the fluid sample from the fluid reservoir into a first portion of the fluidic channel arrangement; preventing, by a valve mechanism, onward flow of the fluid sample from the first portion of the fluidic channel arrangement into a second portion of the fluidic channel arrangement via pressure exerted by the valve mechanism in opposition to the first centrifugal force; and rotating, by the driving mechanism, the fluidic device about the rotational axis at a second higher rotational speed and for a second duration to generate a second centrifugal force sufficient to overcome the pressure of the valve mechanism and drive flow of the fluid sample into the second portion of the fluidic channel arrangement and thereby into the fluid analysis chamber.

In some embodiments, there may be an initial ‘mixing’ spin phase for enabling the fluid sample to fully mix with and dissolve any growth media before the fluid sample (with dissolved growth media) is distributed around the fluidic systems of the device. The initial mixing spin may be for any appropriate duration and speed, but should be selected to ensure that fluid sample is not distributed into the channels of the fluidic system until the growth media has been properly dissolved in the sample. For example, the mixing phase may comprise reciprocal or oscillatory (alternate clockwise and anticlockwise/forward and backwards) rotation of the fluidic device at a speed of between about 250 rpm up to about 750 rpm; such as between about 400 rpm and 600 rpm. In one beneficial embodiment, the oscillatory mixing step is approximately 500 rpm. Such initial mixing may be performed for a duration of about 30 seconds to 1 minute, up to about 10 minutes, as appropriate according to the solubility of the media. For example, the inertial mixing may be for a period of between 3 and 10 seconds (e.g. between 4 and 8 seconds, such as 5 or 6 seconds) in each direction for a desired number of repeats, e.g. between 3 and 10 repeats, between 4 and 8 repeats; or for 5 or 6 repeats. In one beneficial embodiment, the initial media mixing phase may be performed for 5 cycles of 5 seconds in each direction, particularly at a speed of approx. 500 rpm.

In some embodiments of this method, the first rotational speed for distributing the fluid sample and clarifying the sample may be between about 1,800 and 3,000 rpm; such as between about 2,000 and 2,800 rpm or between about 2,200 and 2,600 rpm. In one beneficial embodiment the first rotational speed is approximately 2,600 rpm. The first rotational speed may be applied for a duration of up to about 30 seconds; such as between about 10 seconds and 20 seconds. In one beneficial embodiment, the first rotational speed is applied for a duration of approximately 15 seconds. In some embodiments, however, longer first spin times may be selected (e.g. about 1 minute or more), depending on the type of particles that it is intended to remove. Suitably, this rotational speed and time is sufficient to fill the first portion of the fluidic channel arrangement with a portion of the fluid sample and to sediment particular matter in the fluid sample to create a clarified sample. Preferably, particulate matter of about 10 μm diameter and above is sedimented in the first portion of the fluidic channel arrangement.

In any embodiments, the second rotational speed for filing the analysis chambers is suitably above about 1,900 rpm: for example, between about 2,800 and 4,500 rpm; such as between about 3,000 and 4,200 rpm, or between about 3,200 and 4,000 rpm. In one beneficial embodiment the second rotational speed is approximately 4,000 rpm. The second rotational speed is determined according to the valve mechanism which provides an opposing pressure against movement of the fluid sample towards and past the valve mechanism. In embodiments, the second rotational speed may be applied for a duration of about 10 to 30 seconds; such as between about 12 and 25 seconds, or between about 14 and 20 seconds. In one beneficial embodiment, the second rotational speed is applied for a duration of approximately 15 seconds. Rotating the fluidic device at the second rotational speed allows fluid sample to fill the analysis chamber.

Subsequently, embodiments of this aspect may comprise rotating the fluidic device at a third, slower rotational speed of between about 1,300 rpm and 1,500 rpm. At this speed the gas within the valve mechanism 8 is able to expand and once again provides sufficient pressure to prevent movement of fluid past the valve. This creates a physical gas barrier between fluid within the first portion of the fluidic channel arrangement, and fluid within the second portion of the fluidic channel arrangement.

The method may further comprise providing a predetermined amount of one or more antibiotic in a portion of the fluidic channel arrangement, which antibiotic is in a form that, on contacting the fluid sample, readily dissolves in the fluid sample in order to achieve a predetermined desired concentration of antibiotic. Beneficially, the antibiotic is provided in dried form, for example, on a surface of the analysis chamber. In some cases, the antibiotic may not immediately dissolve in the fluid sample, and so the method may further comprise performing inertial mixing to encourage dissolution of the antibiotic (or other agent) in the fluid sample.

Accordingly, the method may further comprise, after the analysis chamber has been filled with fluid sample, performing a subsequent inertial mixing step, comprising reciprocal or oscillatory rotation (alternate clockwise and anticlockwise rotation) of the fluidic device at a speed of between about 500 rpm up to about 2,000 rpm; such as between about 800 rpm and 1,800 rpm or between about 1,000 rpm and about 1,600 rpm. In one beneficial embodiment, the oscillatory inertial mixing step is approximately 1,500 rpm. Such inertial mixing may be performed for any appropriate duration: typically, for a duration of about 30 seconds to 1 minute, up to about 10 minutes, as appropriate according to the solubility of the drug or other chemical. For example, the inertial mixing may be for a period of between 3 and 10 seconds (e.g. between 4 and 8 seconds, such as 5 or 6 seconds) in each direction for a desired number of repeats, e.g. between 3 and 10 repeats, between 4 and 8 repeats; or for 5 or 6 repeats. In one beneficial embodiment, the inertial mixing may be for 5 cycles of 6 seconds in each direction, particularly at a speed of approx. 1,500 rpm.

The method may further comprise rotating the fluidic device at a predetermined speed while performing an assay on fluid within the analysis chamber. For example, the method may comprises analysing the individual (drug-dosed) fluid samples in each of the analysis chambers by exposing them to a source of light, whereby the amount of light scattering—caused by particulate matter, such as bacteria present in each sample—is measured or simply detected as a function of time. Changes in the amount of light scatter by a sample may be indicative of the amount (e.g. concentration) of particulate matter—especially bacteria—present in the fluid samples. Beneficially, the method involves detecting a reduction in the amount of light scatter as an indication of the susceptibility of the relevant bacterial strain (or strains) present in the sample to the drug, or to the concentration of the drug, used to dose that sample. In some embodiments the amount of light scatter may be proportional to the relative or even the absolute concentration of bacteria in a sample; and may be determined by an appropriate algorithm based on the amount of light scattered.

The method in this aspect may further comprise the analysis of the samples in each fluid analysis chamber. During the analysis, the fluidic device is suitable rotated at a constant rate in the same direction, e.g. at between about 50 and 300 rpm; such as between 100 and 200 rpm; and particularly at about 100 rpm or about 150 rpm. The duration of rotation at this rate is dependent on the length of the assay, and may be for a period of time of between about 20 and 90 minutes; such as between about 30 and 75 minutes, or between about 30 and 60 minutes. The method suitably comprises illuminating, in turn, the fluid sample in each analysis chamber at a predetermined time interval determined by the speed of rotation; and measuring, by a photodetector, the amount of light that is scattered by particulates (such as bacteria) within the fluid sample. Conveniently, the amount of light scattered may be correlated or is proportional to the amount and/or concentration of particulate matter (e.g. bacteria) in the fluid sample. Thus, an increase in scattered light is indicative of an increase in the amount of particulates (e.g. bacteria), and vice versa.

In some embodiments, the analysis is based on a (weighted) rolling average of sample measurements. Beneficially, the rolling average may be applied over from 50 to 500 measurements—particularly over 100 measurements, which equates to 60 seconds of reading for each analysis point at a rotation rate of 100 rpm.

In embodiments, the fluidic device comprises a plurality of detection chambers, at least two of the plurality of detection chambers containing a fluid sample dosed with different amount of the same drug/agent/antibiotic to provide two different concentrations of the drug in the respective fluid samples. The method may then comprise: sequentially locating each of the plurality of detection chambers containing the drug-dosed sample in the light emitted along an incident beam axis; carrying out each subsequent step of the method in respect of each of the plurality of detection chambers; and determining the relative susceptibility of the bacteria in the samples to the respective concentrations of the drug used to dose the fluid samples, thereby to identify the most effective drug concentration for use in a therapeutic treatment regime. In the same or alternative embodiments, the fluidic device comprises a plurality of detection chambers, at least two of the plurality of detection chambers containing a fluid sample dosed with different drugs/agents/antibiotics to provide two different active agents against the same bacteria. The method may then comprise: sequentially locating each of the plurality of detection chambers containing the drug-dosed sample in the light emitted along an incident beam axis; carrying out each subsequent step of the method in respect of each of the plurality of detection chambers; and determining the relative susceptibility of the bacteria in the samples to the respective drug/agent/antibiotic used to dose the fluid samples, thereby to identify the most effective drug for use in a therapeutic treatment regime.

Suitably, the method may further comprise: collecting, by a second photodetector, non-scattered light passing through the or each detection chamber parallel to the incident beam axis; and comparing an intensity of the non-scattered light collected by the second photodetector with an intensity of the scattered light collected by the first photodetector in respect of the same detection chamber.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The above and other aspects of the disclosure will now be described, by way of example only, with reference to the accompanying drawings, in which:

FIG. 1 is a side view of a sample container body comprising a plurality of fluidics systems, through which sample fluids may be centrifugally motivated, according to an embodiment of the present disclosure;

FIG. 2A shows a plan view of the sample container body of FIG. 1; and FIG. 2B shows an expanded view of one of the fluidics systems provided in the sample container of FIG. 2A. FIG. 2C shows a plan view of the sample container body according to an alternative embodiment; and FIG. 2D shows an expanded view of some of the fluidics systems provided in the sample container of FIG. 2C;

FIG. 3 is a vertical cross-sectional view of the assembled sample container body 2 of FIG. 1, illustrating various flow paths of the clinical sample fluid in a central portion of the container;

FIG. 4 is vertical cross-sectional view of an assembled fluidics device 1 comprising the sample container body of FIG. 3, which also includes a cap for securing the clinical sample fluid within the sample container;

FIG. 5A shows an exploded view of a fluidics device 1 according to another embodiment of the present disclosure that may be used to implement a method of clinical sample analysis; and FIG. 5B shows a cross-sectional view of the fluidics device 1 according to this embodiment. FIG. 5C shows an exploded view of a fluidics device 1 according to another embodiment of the present disclosure; and FIG. 5D shows an exploded view of a fluidics device 1 according to yet another embodiment of the present disclosure;

FIG. 6A is a bottom, perspective diagram of the container cap shown in FIGS. 5A and 5B; and FIG. 6B is a side view of the container cap of FIG. 4;

FIG. 7A is a top, perspective exploded view of the container cap shown in FIGS. 5C and 5D; and FIG. 7B is a bottom view of the container cap of FIGS. 5C and 5D;

FIG. 8 is a flow diagram illustrating various steps of a method of manufacturing the complete sample container and cap according to an embodiment of the present disclosure;

FIGS. 9A to 9E show schematic snapshots of a sample container during a process of redistributing sample fluid from a central reservoir of the container into individual fluidic systems, according to an embodiment of the present disclosure;

FIG. 10 is a flow diagram illustrating various steps of the method of redistributing sample fluid as used in relation to FIGS. 9A to 9E;

FIG. 11 shows a vertical cross-sectional diagram of an optical analysis apparatus which may be used, in combination with the sample container shown in the above-described figures, to determine susceptibility of bacteria in clinical samples to various drugs;

FIG. 12 is a perspective diagram of a portion of the apparatus of FIG. 11;

FIG. 13 is a bottom perspective diagram of a sample carousel present in the apparatus of FIG. 11 and that interfaces with the fluidic device described and shown herein;

FIG. 14 is a schematic diagram of an optical arrangement used in the apparatus of FIG. 11 in an example implementation;

FIG. 15 is a flow diagram illustrating various steps of a method of determining drug susceptibility of bacterial in a clinical sample using the apparatus of FIG. 11 and the sample container described herein;

FIG. 16 shows different plots of detector intensity output as a function of time in the apparatus of FIG. 11, illustrating the effects of different antibiotics on bacteria in a clinical sample; and

FIG. 17 shows an alternative arrangement of a fluidics system for use in accordance with embodiments of the disclosure.

In the drawings, like features are denoted by like reference signs.

### DETAILED DESCRIPTION

Specific examples and embodiments of the disclosure will now be described in which numerous features will be discussed in detail in order to provide a thorough understanding of the concepts defined in the claims. However, it will be apparent to the skilled person that the disclosure may be put into effect without all of the specific details and that in some instances, well known methods, techniques and structures have not been described in detail in order not to obscure the disclosure unnecessarily.

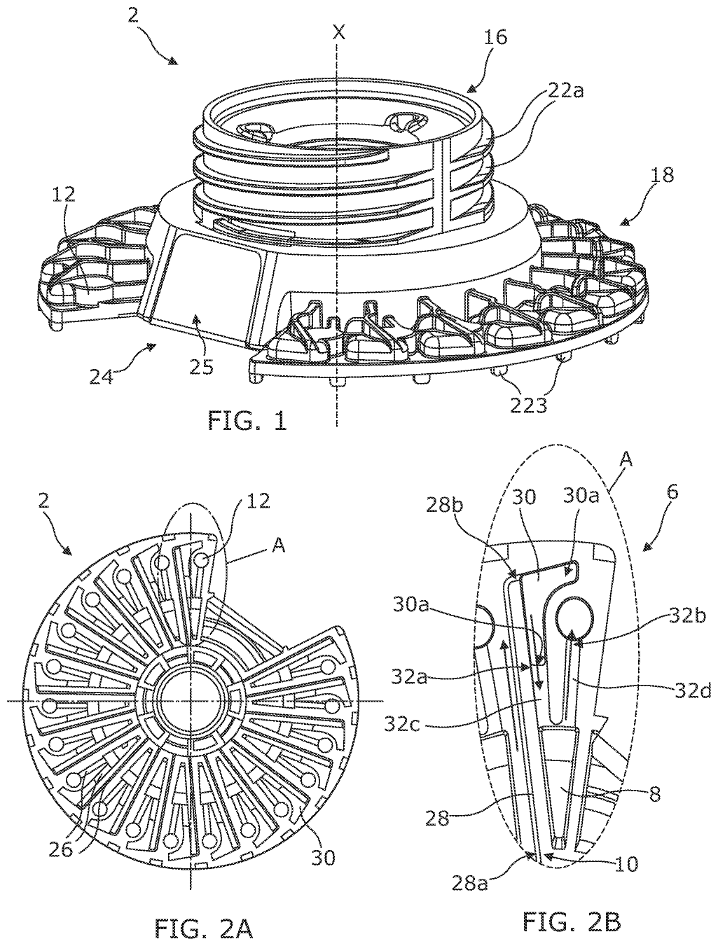

FIG. 1 illustrates a portion of a fluidic device 1 which is configured to enable centrifugally motivated distribution/movement of portions of a fluid sample through a plurality of fluidics systems; the sample portions are retained in individual detection/analysis chambers for subsequent analysis.

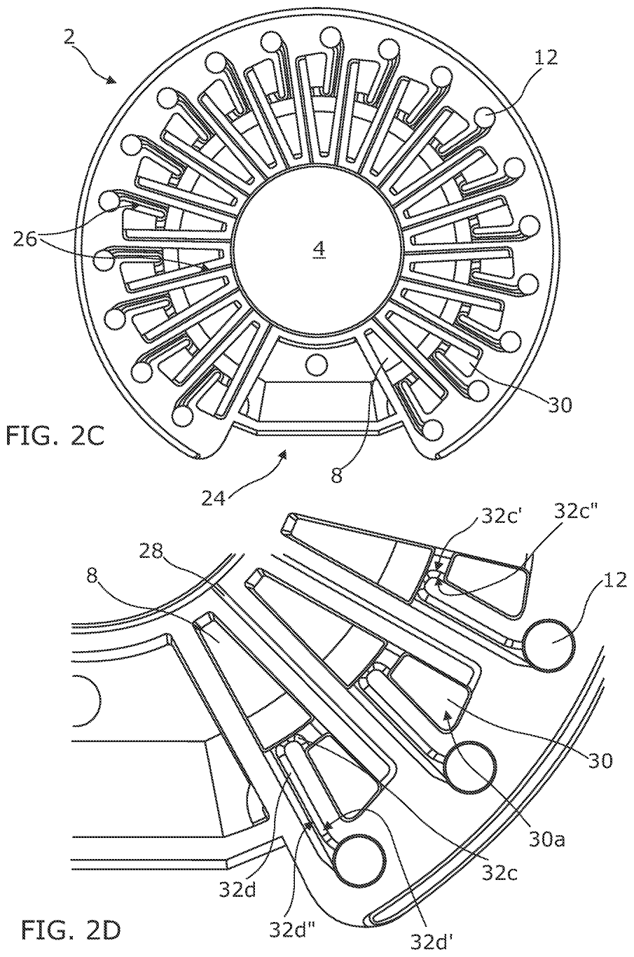

In its most general sense, the fluidic device 1 (see also FIGS. 2 to 5D) comprises a body 2 having a main fluid reservoir 4 provided centrally therein into which the fluid sample is initially introduced and retained. A plurality of fluidic systems 6 are provided at intervals around the main fluid reservoir 4, extending radially outwardly from and in fluid communication with the main fluid reservoir 4. In use, rotational motion of the fluidic device 1 around a central rotational axis ‘X’ is configured to apply centrifugal force to a fluid sample retained in the main fluid reservoir 4, to thereby drive smaller portions of the initial fluid sample into each of the individual fluidics systems 6.

Subsequent flow of the fluid sample through the individual fluidics systems 6 is controlled via a combination of one or more different centrifugal forces being applied (e.g. by implementing various rotational speeds, applied for certain predetermined time intervals). Additional control of fluid flow is achieved via the use of one or more valve mechanisms/pneumatic springs located at strategic points within the respective fluidics system. In particular, in each fluidics system 6, a valve mechanism 8 is located at an intermediate point in the flow path between an entry point 10 of the fluidics system and a fluid analysis chamber 12. This valve mechanism 8 is configured to exert a pressure in opposition to the flow force of the fluid sample, and to thereby prevent fluid flow into the fluid analysis chamber 12, when the container 1 is rotated at a speed below a predetermined threshold speed. In this instance, the centrifugal force exerted upon the fluid sample by rotation of the container 1 will be insufficient to overcome the opposing force of the compressed gas in the valve mechanism 8 until the fluidic device 1 is rotating at a sufficiently high speed.

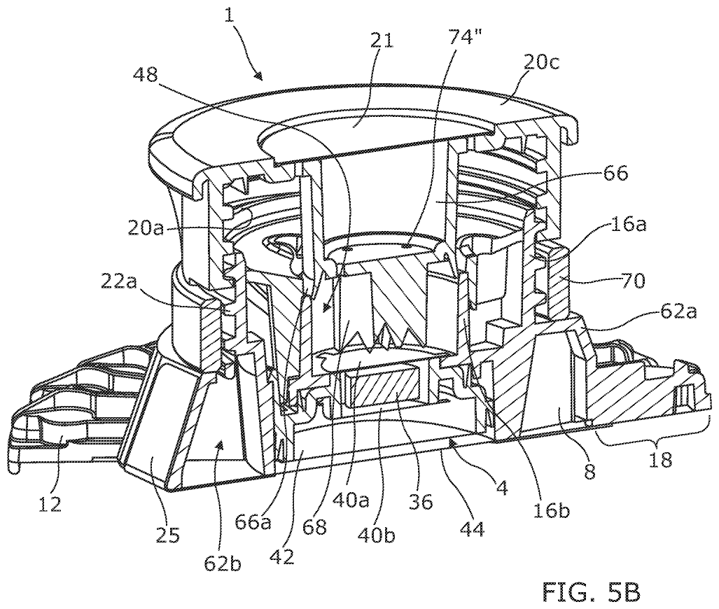

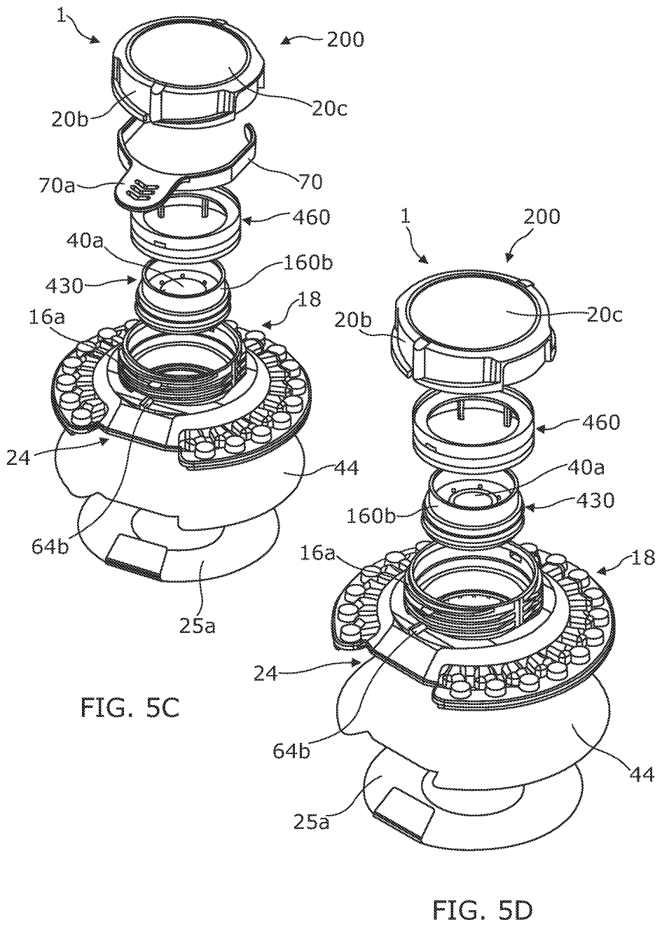

Typically, in aspects and embodiments of the disclosure, the sample container body 2 of FIG. 1 is formed and moulded from an optically transparent substrate material (for example, a plastics material such as polycarbonate). The container body 2 is generally circular in vertical cross section and is divided into two main portions: (i) a radially inner walled portion 14 having the main fluid reservoir 4 formed therein and having walls extending upwards to form a cylindrical container neck 16; and (ii) a radially outer portion 18 having the plurality of fluidics systems 6 formed therein. The container neck 16 is configured to receive a cap or cover 20 that may be secured to the container body 2, in use, to ensure the fluid sample is securely retained within the assembled container 1. In this regard, the container neck 16 in the illustrated embodiment comprises a plurality of external protrusions/threads 22a that are configured to engage with corresponding internal protrusions/threads 20a provided on the cap 20 (as shown in more detail in FIGS. 5 and 6) so as to enable secure engagement between the cap 20 and the container body 2. Of course, it will be appreciated that any other appropriate mechanism for securing a cap to a container body may alternatively be used, such as snap-fit or friction mechanisms or clips/clamps/latches. For the sake of clarity and disclosure, it should be appreciated that various embodiments of this disclosure are not intended to be limited by necessarily including every feature described in relation to the figures, especially where it is made apparent that particularly described features are not essential or are optional.

In the embodiment shown in FIG. 1, the outer portion 18 of the container body 2 comprises a cut-out segment 24 that is configured to enable easy, orientation-specific interface and engagement of the fluidic device 1 with a device comprising an optical analysis apparatus that is utilised during subsequent analysis of a fluid sample in the container assembly 1. Accordingly, the ‘generally circular’ container body 2 may comprise a radial cut-out. The cut-out segment 24 further comprises an angled wall 25 on the radially inner surface of the cut-out segment 24 upon which may be positioned an identification code (e.g. in the form of an RFID tag or barcode) or other information that may be used to store details of the fluidic device 1 and its contents. As will be described in more detail subsequently, the cut-out segment 24 may be sized and configured to interface with a portion of an optical analysis apparatus during subsequent use for analysis of the fluid sample, and so can be any appropriate size and shape. For reasons of practicality and efficiency in maximising the number of fluidics systems 6, the cut-out may, for example, subtend an angle of between approx. 20° to 60°, suitably between approx. 30° and 50°; but any appropriate angle that helps to serve the purposes of correct alignment of the device in an analysis apparatus can be beneficial.

FIG. 2A illustrates a plan view of the container body 2 of FIG. 1 to highlight further details of the main fluid reservoir 4 and the fluidics systems 6 provided therein, while FIG. 2B shows an enlarged view of one of the fluidics systems 6. As was previously mentioned, each fluidics system 6 comprises a fluid analysis chamber 12 which represents the final destination of the fluid sample portion within that particular fluidics system 6. In addition, each fluidics system 6 comprises a fluidic channel arrangement 26 providing a fluid flow path communicating between the main fluid reservoir 4 at the centre of the container body 2, and the respective fluid analysis chamber 12 at a radially outer portion of the container body 2.

In more detail, the fluidic channel arrangement 26 comprises a first entry fluidic channel 28 having an entry port 28a at its radially innermost extent (relative to the rotational axis X of the container 1) that is in communication with the main fluid reservoir 4; and an exit port 28b at its radially outermost extent that is in communication with an intermediate separation or clarification chamber 30. In the illustrated embodiment, the exit port 28b is located towards the radially outermost limit of the fluidics system 6. In other embodiments—for example, as depicted in FIGS. 2C and 2D—the separation chamber 30 is not located at the radially outer point of the fluidics system 6.

With particular reference to FIG. 2B, the separation chamber 30 takes the form of a well formed in the substrate of the radially outer portion 18 of the container body 2 and is configured to enable the separation of unwanted particles/impurities from the rest of the fluid sample. The exit port 28b of the first fluidic channel 28 communicates with the separation chamber 30 towards its radially outermost wall/edge, thereby achieving what may be considered a ‘bottom-feeding’ functionality for introducing sample fluid into the separation chamber 30 (i.e. the fluid sample enters the separation chamber 30 at its radially outermost extent). In any embodiments, therefore, the fluidic channel 28 beneficially communicates with the separation chamber 30 at the radially outermost edge of the separation chamber 30. However, in some embodiments the separation chamber 30 is advantageously shaped such that the radially outermost wall is angled obliquely away from the axis of rotation X and the exit port 28b of the fluidic channel 28 (e.g. to form a sedimentation zone spaced from the port 28b). In this way, particles in the fluid entering the sedimentation chamber 30 sediment and concentrate at a distance from port 28b, e.g. in a ‘toe’ or ‘pocket’ 30a of the separation chamber 30, such that sediment is not disturbed by incoming fluid, which would be detrimental to the process of creating a clarified fluid sample. Once within the separation chamber 30, the fluid in the radially inner portion of the sedimentation chamber 30 is clarified. By ‘bottom feeding’ of incoming fluid sample (i.e. incoming fluid enters the sedimentation chamber 30 towards the radially outer limit of the chamber), it is the clarified fluid that will be pushed out of the sedimentation chamber 30 towards the valve mechanism 8 and analysis chamber 12 when desired (as described further below). By contrast, if the port 28b was located towards the radially inner edge of the sedimentation chamber 30, incoming fluid from the main fluid reservoir 4 (via fluidic channel 28) would mix with clarified fluid in the radially inner portion of the sedimentation chamber 30 and would risk pushing non-clarified fluid towards the analysis chamber 12. In addition, the bottom-feeding arrangement may allow the fluidic system to enable fluid progression from the main fluid reservoir 4 to the analysis chamber 12 with the use of only one pneumatic gate/air spring. This reduces complexity of manufacture and subsequent control of fluid sample movement based on control of rotational speed rather than by operation of hard/mechanical valves.

The fluidic channel arrangement 26 further comprises a second fluidic channel 32 having an entry port 32a in communication with the separation chamber 30, and an exit port 32b in communication with the fluid analysis chamber 12. A weir (or step) 30a is located between the separation chamber 30 and the entry port 32a of the second fluidic channel 32 which may help to improve the separation/clarification functionality provided by the separation chamber 30. In view of the weir 30a, the volume of clarified fluid sample within the separation chamber 30 must reach a sufficiently large amount in order to overflow the weir and enter the second fluidic channel 32, while unwanted impurities may be retained within (and in fact settle against the radially outer wall of) the separation chamber 30. Indeed, centrifugal force acting on the liquid sample, in use, pushes heavier particles/unwanted impurities outwards to the most radially outer wall of the separation chamber 30, such that they are held in a position that is furthest from the weir 30a, which, as depicted, is typically located at the radially inner edge of the separation chamber 30: this, and the further beneficial feature of the port 28b being located towards the radially outer wall of the separation chamber 30, reduces the possibility of unwanted particulate matter being pushed/drawn into the second fluidic channel system 32.

Usefully, as may be used in any of the aspects and embodiments of this disclosure, the presence of weir 30a raises the height of the floor/base of fluidic channel 32 relative to the floor of separation chamber 30 and helps to minimise the volume of fluid which must be passaged through fluidic channel 32. By minimising the volume of liquid that is displaced by centrifugal force towards the valve mechanism 8, the volume of gas displaced into the valve mechanism 8 is similarly reduced/minimised, which in turn reduces the pressure increase within the valve mechanism 8 and, reduces the rotational speed necessary to push liquid sample passed the valve mechanism 8 (as explained below). In embodiments, the rotational speed of the container 1, in use, is selected with the aim of capturing/sedimenting particles with a diameter of more than 10 μm, thus allowing relevant bacteria to remain in suspension.

The second fluidic channel 32 is substantially U-shaped and comprises first and second channel arms 32c, 32d arranged to provide fluid flow paths in generally antiparallel directions. Specifically, the first channel arm 32c extends roughly (anti)parallel to the first fluidic channel 28, such that the fluid sample can be caused to flow out of the separation chamber 30 and along the first channel arm 32c in a radially inwards direction (towards the rotational axis X of the fluidic device 1); the second channel arm 32d extends roughly (anti)parallel to the first channel arm 32c and enables the fluid sample to reverse its flow direction (relative to the flow in the first channel arm 32c), such that the fluid sample travels in a radially outwards direction towards the fluid analysis chamber 12. Suitably, in any embodiments of the present disclosure, each of the fluidic channels 28, 32a and 32b are arranged approximately radially.

The two channel arms 32c, 32d are in fluid communication with one another, at their radially innermost extents, via the valve mechanism 8 which (in the illustrated embodiment) takes the form of a storage chamber filled with gas (such as air) which is compressed and put under increased pressure as fluid (liquid) moves through the fluidic channels of the fluidic system 6 towards the valve mechanism 8. The compressed gas can thus be configured to block/prevent fluid flow between the two channel arms 32c, 32d by exerting gas pressure in opposition to the centrifugal force applied to the fluid sample via rotation of the fluidic device 1. Such a valve mechanism is also sometimes known in the art as a ‘pneumatic (by-pass) valve’, ‘pneumatic spring’, an ‘air ballast chamber’ or an ‘air spring’.

A modified embodiment of the fluidic device 1 will now be described with reference to FIGS. 2C and 2D. In this embodiment, the separation chamber 30 communicates with the main/central fluid reservoir 4 via the fluidic channel 28 as before, via an inlet in a radially outer portion/edge of the separation chamber 30. The separation chamber 30 is beneficially formed in a wedge shape having a wider end/portion radially outside of a relatively narrow radially inner end/portion. In this way, sediment may conveniently be collected in a region 30a of the sedimentation chamber 30 distant to the point of communication (28b) of the fluidic channel 28 with the separation chamber 30, to mitigate against incoming fluid disturbing any sediment that has been separated from the clarified fluid in the separation chamber 30, and the wedge shape of the sedimentation chamber 30 also helps to optimise the use of the available area of the circular/disc shape of the fluidic device at different radial distances from the central reservoir 4.

In this embodiment, the first channel arm 32c, which communicates between the separation chamber 30 and the valve mechanism 8 is relatively short, and the second channel arm 32b that communicates between the valve mechanism 8 and the fluid analysis chamber 12 due to the location of the separation chamber 30 radially between the valve mechanism 8 and the fluid analysis chamber 12. In this way, a greater centrifugal force and pressure from the valve mechanism 8 combine to help retain the fluid sample inside the analysis chamber 12 during the incubation and measurement phase of the disclosed methods, which are described further below.

Optionally, in this and any other aspects and embodiments described herein, the internal corners 32d′ and 32d″ of the channel arm 32d may be rounded (having increased curvature) to reduce any wicking/capillary forces that might detrimentally counter the movement or retention of the fluid sample in(to) the analysis chamber 12. Similarly, the internal corners 32c′ and 32c″ of the channel arm 32c may also be rounded so as to avoid sharp corners at close to 90°. It may also, of course, be desirable to form the internal corners of the fluidic channel 28 with a slight curvature to avoid wicking/capillary forces in this channel. For example, in a fluidic channel of approx. 1.5 mm width and approx. 0.75 mm depth, the internal corners may have a curvature with a radius of between approx. 0.05 and 1 mm. In some examples, the radius of curvature is approx. 0.6 mm; in other examples, the radius of curvature is about 0.1 mm, about 0.2 mm or about 0.3 mm.

The mechanism by which the fluid sample is distributed within the container body 2 will be described in greater detail subsequently; however, a brief summary of the flow path taken by the fluid sample through the fluidic system 6, between the main fluid reservoir 4 and one of the fluid analysis chambers 12, will now be provided to place the above-described elements of the fluidic system into context.

The sample fluid is initially located in the main fluid reservoir 4; the fluidic device 1 is rotated at a first speed that generates sufficient centrifugal force so as to drive a smaller portion of the sample fluid into each of the fluidic systems 6: specifically, the fluid sample portion enters each fluidic system 6 through a respective one of the plurality of first fluidic channels 28 and into a respective separation chamber 30. This first rotational speed is maintained for a first duration of time sufficient to drive enough fluid into each fluidic system 6 to fill each fluidic channel 28 and then begin to fill the separation chamber 30 and allow time for particulate matter to sediment out of solution in the separation chamber 30. In use, the speed of rotation may be selected to allow time for filling of the separation chamber 30 with fluid sample and to prevent fluid sample from being driven onwards towards the air spring/valve mechanism before it is desired to do so. A weir 30a (or dam/partial wall) at the radially inner edge of the sedimentation chamber 30 serves to retain fluid within the sedimentation chamber 30 until clarified/it is desired to create onwards movement of the fluid towards the analysis chamber 12. Once sedimentation is sufficiently complete, the level of the fluid sample portion in each system 6 can be raised by increasing the speed of rotation. As clarified solution in each fluidic system 6 reaches the top of its respective weir 30a it overflows and enters the associated first channel arm 32c. However, this first speed is selected to be too low to impart sufficient centrifugal force to the fluid sample to allow the sample to overcome the opposing pressure now generated within the valve mechanism 8 by the compression of gas within that volume, and so the fluid cannot pass the valve 8 to enter the second channel arm 32d. In other words, the movement of sample fluid with respect to the valve mechanism 8 may be controlled by the balance/difference between pressures: i.e. the centrifugal pressure difference caused by the rotating disc must overcome the increased pressure (overpressure) caused by the reduced gas volume before liquid will move past the valve mechanism 8.

In order to force the liquid sample further towards the analysis chamber 12, the fluidic device 1 is rotated at a second, higher speed that does generate sufficient centrifugal force to overcome the valve mechanism 8 gas pressure—the ‘seal’ (pressure block) provided by the valve mechanism 8 is thereby overcome and the fluid sample is able to flow into the second channel arm 32d. Continued rotation at this second speed drives additional fluid through the second channel arm 32d, causing the fluid sample to enter and fill the fluid analysis chamber 12. Generally, the analysis chamber 12 takes the form of a cylindrical well provided in the substrate of the container body 2. Beneficially, in any embodiments of the invention, the second channel arm 32d communicates with the analysis chamber 12 towards the base of analysis chamber 12. In this way, movement of the clarified fluid sample towards and into the analysis chamber 12 allows gas previously within the second channel arm 32d and analysis chamber 12 to move out of the analysis chamber 12 and back—radially inwardly—towards the valve mechanism 8. This avoids a pressure block occurring in the analysis chamber 12 and/or air bubbles being trapped in the analysis chamber 12, which may detract from the accuracy/sensitivity of the analysis to be performed on the fluid sample. Once sufficient fluid has passed through the valve mechanism 8, the rotational speed of the container 1 can be reduced to retain the fluid sample within the fluid analysis chamber 12 and the second channel arm 32d, but prevent (due to the valve mechanism 8 gas pressure) backflow of the fluid sample into the first channel arm 32c. By way of explanation, by reducing the rotational speed, the air in chamber 8 is free to expand once more as there is less pressure force on it. When this happens, the fluid in chamber 30 is pushed back up channel 28 into the central chamber 4. This creates an air barrier between the fluid in the analysis chamber 12 and fluid in the separation chamber 30 and central reservoir 4 so no cross contamination can occur. Moreover, any backflow of fluid from the analysis chamber 12 is prevented because once the analysis chamber 12 is evacuated of gas, there can be no force pushing the liquid sample radially inwards towards the valve mechanism 8.

It will be appreciated that the gating level of the valve mechanism 8 may determine the internal pressure changes within the fluidics system 6 that are necessary to move fluid through the channels 28; 32 and chambers 30 towards the respective analysis chambers 12. Therefore, in embodiments where the valve mechanism is a pneumatic by-pass valve or ‘air spring’, it will be appreciated that the volume of the valve mechanism 8 may be selected to provide the appropriate resistance/gating against fluid movement having regard to: (i) the volume of fluid that must be pushed through the fluidics system 6 to fill the analysis chamber 12; and (ii) the desired speed of rotation of the fluidic device 1 during the analysis process. For example, a larger volume of air spring reduces the rotational speed necessary to move a defined volume of fluid sample passed the valve, because the additional gas compressed into the air spring (by movement of the defined volume of liquid sample) causes a relatively smaller increase in gas pressure in the valve mechanism 8 that must be overcome by centrifugal force.

In embodiments of this disclosure, therefore, the volume of the air spring may suitably be related to the volume of the detection chamber, which may accordingly be related to the volume of the sedimentation chamber 30, which must clarify sufficient fluid to fill the analysis chamber 12. Thus, the volume of the sedimentation chamber 30 is suitably about 2 times the volume of the analysis chamber 12, and the volume of the air spring 8 is suitably in the range of about 2 to 4 times the volume of the sedimentation chamber 30. For example, the volume of the air spring 8 may be in the range of about 150 to 600 μl. By comparison, the volume of the analysis chamber 12 may be in the range of about 30 to 150 μl, and the volume of the sedimentation chamber 30 may be in the range of about 60 to 300 μl. In specific embodiments of this disclosure, the air spring 8 has a volume of about 400 μl; the analysis chamber 12 has a volume of about 50 μl; and the sedimentation chamber 30 has a volume of about 100 μl. In other specific embodiments of this disclosure, the air spring 8 has a volume of about 400 μl; the analysis chamber 12 has a volume of about 125 μl; and the sedimentation chamber 30 has a volume of about 200 μl.

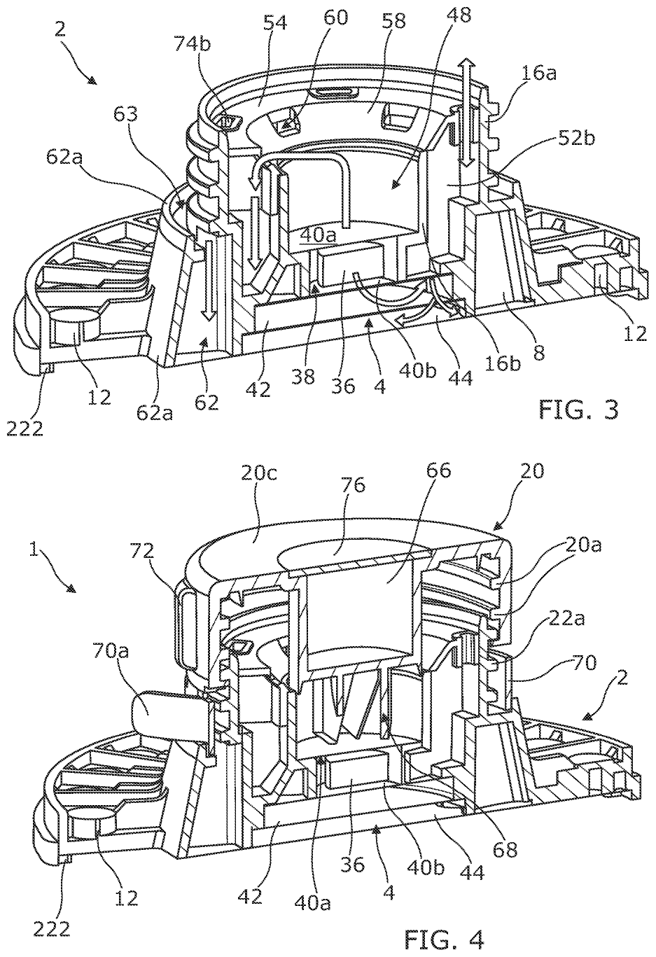

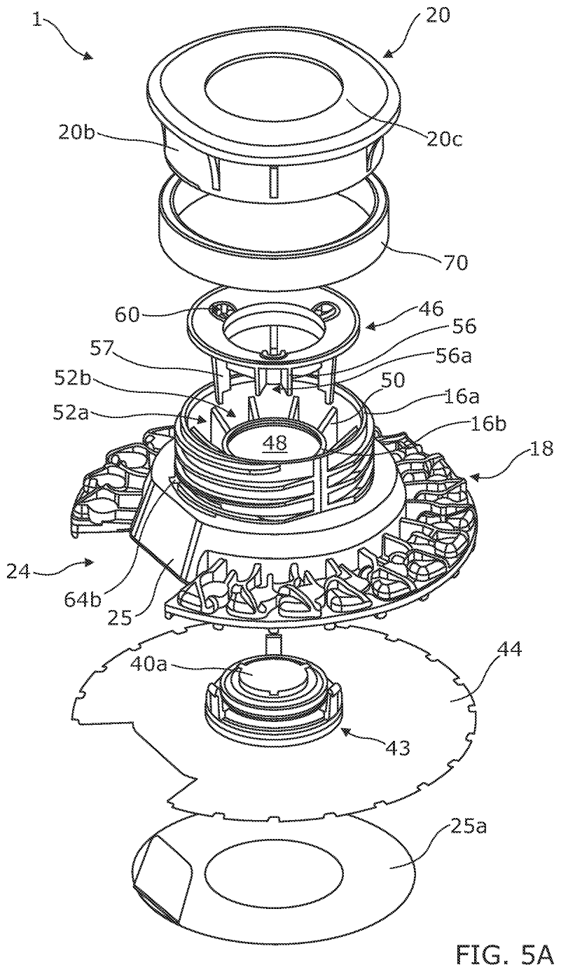

In view of the general profile of the sample container body 2, which may conveniently be generally disc-shaped with a raised inner core to contain filter 42, media 36, sample receiving well/reservoir 48 (see e.g. FIGS. 1, 3 and 4), the necessary volume of the valve mechanism e.g. an air spring 8 may thus encompass a relatively large proportion of the outer region 18 of the sample container body 2—particularly when, according to preferred embodiments of the disclosure, the valve mechanism 8 is located in the relatively smaller volume of the radially innermost part of the outer region of the sample container body 2. Thus, when the largest dimensions of the valve mechanism 8 (‘air spring’) are arranged generally in the plane of the fluidics system, i.e. in an axial plane of the container body 2, more surface area is encompassed by the valve mechanism 8, and the larger the container body 2 must be in the radial direction in order to accommodate the desired number of fluidics systems 6, or the less fluidics systems 6 that can be accommodated in the device. In some embodiments of the disclosure, there may be a desire to form a generally flat device 1, e.g. to improve stacking of the devices 1. However, an increased size of container body may be undesirable for a number of reasons, such as environmentally (increased amounts of material (e.g. plastic) to be used and disposed of); and economically (for example, transport, storage, and requiring a larger diagnostic/assay device purely for compatibility with the container body 2). Desirably, therefore, the device 1 and body 2 may be made as small as possible—especially in the radial dimension, while retaining the maximum desirable number of fluidics systems 6. In line with these aims, it has been found beneficial to configure the orientation of the valve mechanisms 8 such that the major dimension of the valve 8/air chamber is perpendicular to the radial axes of the container body; i.e. the main dimension of the valve 8 is arranged essentially parallel with that X axis through the central region of the container body 2 and main fluid reservoir 4. Thus, as best shown in FIGS. 3 and 4, the valve mechanism 8 of each of the fluidics systems 6 may be provided by respective air chambers 8 arranged around the perimeter of the main fluid reservoir 4 and sample receiving well 48. In embodiments, the air chambers of the plurality of valve mechanisms 8 may be located axially below and outer wall 16a of the neck 16 and, in particular, may be arranged circumferentially around the main fluid reservoir 4 and filter element 42 and oriented generally axially so as to reduce the depth of the valve mechanisms 8 in a radial dimension. In this way, the size (particularly the radial dimension) of the container body 2 can be reduced while maintaining the same or improved functionality.

In a specific embodiment, the fluidic device 1 described above may form part of a larger overall system or device that is used to process and analyse properties of clinical fluid samples (such as urine or blood). Furthermore, this analysis may involve the assessment/analysis of light scattering caused by the concentration of particulate matter (e.g. bacteria) within the clinical sample. In this way, the fluidic device 1 may particularly be used for ascertaining the drug susceptibility of bacteria in order to identify an appropriate treatment for the infected subject who provided the sample. In some implementations, the device may be used in a method for assessing the relative concentration of light-scattering particles in fluid samples, or for estimating the amount or concentration of light scattering particles in a fluid sample. In particular embodiments, the ‘concentration gradient’ of light scattering particles, such as bacteria may be determined.

The description that will now be provided in relation to FIGS. 3 to 7 involves the illustration of various aspects and embodiments of fluidic devices 1 in the particular use context of clinical sample analyses for determining bacterial drug susceptibility. However, it will be appreciated that these fluidic devices 1 may potentially also have other uses (as noted above) and that some of the features described subsequently may be altered as a result to accommodate such uses.

With particular reference to FIGS. 3 and 4, these show vertical cross-sectional perspective views of the container body 2 (FIG. 3) of FIG. 1 and of a microfluidic device 1 comprising the container body 2 (FIG. 4), which have been configured for use in clinical sample analysis according to various embodiments of the present disclosure. In addition to the main body 2 of the sample container described earlier, the fluidic device 1 further comprises a growth media or medium 36 (typically provided in solid form in such embodiments) which promotes the growth of bacteria in the clinical sample fluid for analysis of growth characteristics. Conveniently, as in the depicted embodiment, the growth medium is dried (e.g. lyophilised or freeze-dried) and in solid form. However, a powdered, dry growth medium may also be used and may aid in rapid dissolution of the media in a fluid sample. In particular, a powdered form of growth media may be contained in a dissolvable/decomposable capsule, for example, which will release the powder when opened. In alternative embodiments, a concentrated liquid growth media may alternatively be used. The growth media 36 is initially isolated within a compartment 38 located within the inner walled portion 14 (see FIG. 1) of the container body 2 which, in the illustrated embodiment, is located substantially vertically (along the central rotational axis X of the fluidic device 1) above the main fluid reservoir 4 (FIG. 3).

In the depicted embodiment, the growth media compartment 38 is closed at its top and bottom by foil covers 40a, 40b, such that the growth media 36 may be isolated from the outside environment and particularly to ensure separation from the fluid sample when the sample is first introduced into the fluidic device 1. The foil covers 40a, 40b may be attached at their desired locations (e.g. around the periphery of the respective enclosures) using any appropriate heat-sealing techniques (or adhesive or welding) to seal the compartment housing the growth media 36. A filter element 42 is also located below the growth media compartment 38 and above the main fluid reservoir 4, and is secured (e.g. via heat-sealing, adhesive or welding) so as to extend substantially across the internal diameter of the inner walled portion 14 of the container body 2. The filter element 42 provides a mechanism for filtering out impurities of over a predetermined size (as determined by the filter properties) in the sample before the sample enters the main reservoir 4; and may take the form of a porous membrane having pore sizes of around 100 μm. As the skilled person would appreciate, the pore size of the filter is selected such that it allows bacteria in the sample (being only a few microns in size at most) along with the dissolved growth media to pass through the filter and enter the main fluid reservoir 4. However, the filter is selected so as to prevent salts and other relatively large particles in the sample from passing; e.g. pieces of pierced foils, non-dissolved lumps of growth media and large human tissue cells and fibres from the sample. As described below with respect to FIG. 5A, in embodiments the compartment 38 comprising the foil covers 40a, 40b and containing the growth medium 36, as well as the filter element 42, may be conveniently provided in a self-contained capsule component 43 or 430 (see FIGS. 5C and 5D) that is manufactured separately from other components of the main container body 2 and inserted during assembly of the sample container. This will be described in more detail subsequently. It will be appreciated that in some embodiments the foil covers 40a, 40b can be replaced with other means of sealing the media compartment 38. For example, the seals could be made of a paper material or a material that dissolves in a fluid such as the liquid sample. In some embodiments the lower seal 40b may be optional and, instead, a dried media may be held within the media compartment by the filter element 42 directly. In some embodiments the upper seal 40a is also optional and may be omitted. In some embodiments the media may be provided in (concentrated) liquid form.

In a convenient mode of manufacture, the fluidics systems 6 are formed as channels and recesses in the lower surface of the container body 2. Therefore, in order to form a closed system, a base cover 44 having a corresponding surface area footprint to the base of the container body 2 is attached to the bottom of the fluidic device 1 to close the assembly and cover off the fluidic systems 6 and fluid reservoir 4 that are formed in the lower surface of the main part of the container body 2. In some embodiments the container body 2 may be provided with a short wall or lip 222 extending downwards from the perimeter of the container body and the base cover 44 may extend across the base of the container body 2 between the perimeter lip. In other embodiments, the container body may include downwardly projecting pegs or posts spaced about the perimeter of the radially outer portion 18 of the container body 2 in place of a perimeter wall 222. Suitably, the base cover 44 is a film. As will be described in more detail subsequently, the presence of the base cover 44 is important as the fluidics systems 6 are conveniently moulded into the base of the substrate that forms the container body 2. Without the base cover 44, the fluidics systems 6 would be open to the environment and would be unable to contain liquid when the fluidic device 1 is in use. This base cover 44 is optically transparent at least in the region axially below (some of) the analysis chambers 12, to allow subsequent analysis of the bacteria (or other particulate matter to be assessed for light-scattering ability) in the respective fluid analysis chambers 12. In some embodiments the base cover may be opaque to light in particularly defined regions, such as below an analysis chamber 12 which may be to provide for a negative optical control in use. The base cover 44 may be attached to the underside of the sample container body 2 via any one or more of a few well-known suitable sealing techniques, such as heat sealing, ultrasonic welding, liquid adhesive sealing, or the base cover 44 may comprise a single-sided/double-sided adhesive film.

Whichever sealing technique is utilised, it is important to ensure that a high level of optical clarity is maintained and reflection of incident light from the base cover 44 or any adhesive used is minimised (especially in the regions covering the fluid analysis chambers 12) to avoid adversely affecting the subsequent analysis process. In addition, the sealing process should be compatible with (and should avoid interference with) any of the components of the fluidic device 1 (for example, any drugs deposited within the container). In particular, it is desirable that no/minimal adhesive or other chemicals are exposed on the upper surface of the base cover 44 within the fluidics system channels and reservoirs in order to avoid possible contamination of the liquid sample in use. It will also be appreciated that the join between the container body 2 and base cover 44 must be as secure and consistent as possible, to fully seal all channels and chambers and to mitigate against rippling or other undesirable surface effects on the cover 44, which might interfere with consistent light transmission through the analysis chambers 12. Therefore, the surface of the container body 2 to which the cover 44 is attached should be as flat as possible, with minimum surface features or irregularities. For example, it is desired that the flatness is less than about 70 μm (peak deviation from plane), less than about 50 μm, or between about 40 μm and 20 μm or lower.

It is also envisaged that the container body 2 and any other components of the fluidics device 1 may be formed by a suitable additive manufacturing process and in some such processes the base cover 44 may therefore be formed integrally with the main body of the container body 2, thus, obviating the need for a separate base cover 44.

In the depicted embodiment, in order to facilitate the introduction of the fluid sample into the fluidic device 1, a filler insert or funnel 46 is also provided which is located within, and engages with, an upper part of the container neck 16. As shown in FIGS. 3 and 4, the container neck 16 comprises a cylindrical outer wall 16a spaced radially from a cylindrical inner wall 16b. As depicted, the inner wall 16b surrounds and creates a cylindrical sample reservoir or receiving well 48 into which the fluid sample is initially introduced; the receiving well 48 is therefore located concentrically within the cylindrical container neck 16. In the depicted embodiment, a plurality of radial partition walls 50 (best shown in FIG. 5A) are radially arranged at intervals within the container neck 16, extending between the inner wall 16b and the outer wall 16a, to form generally wedge-shaped spaces 52a; 52b between adjacent partitions 50. In embodiments of the disclosure, the spaces 52a, 52b may alternate around the container neck 16.

The funnel 46 comprises an annular rim 54 and a downwardly projecting annular skirt 58 radially inwards of the rim 54 to guide the fluid sample into the cylindrical sample receiving well 48 when the fluid sample is poured into the fluidic device 1 via the funnel 46. In the depicted embodiment, a plurality of apertures or slots 60 are provided in the annular skirt 48 to act as overflow features to reduce the possibility of liquid sample being spilled by over-filling the sample reservoir or receiving well 48. In the depicted embodiment, three slots 60 are formed in the funnel skirt 58, although more or less slots (e.g. 1, 2 or 4) may alternatively be provided. Downwardly projecting from the underside of the funnel 46 around each slot 60, a plurality of projections (e.g. walls) 56 (best shown in FIG. 5A) are positioned to define an open channel 56a. The projections 56 are suitably sized and shaped so as to be complementary to and to be received within the spaces 52a in the container neck 16, such that each open channel 56a may direct overflow fluid into the enclosed receiving space 52a. The projections 56 also beneficially act to secure the funnel 46 in a desired orientation within the neck 16. In addition, as depicted in the embodiment of FIG. 5A, the lower surface of the funnel 46 may also be provided with a plurality of downwardly projecting locating fins or pins 57 which may be configured to contact the radially inner surface of the outer wall 16a of the neck 16. Such pins 57 may further serve to position and secure the funnel 46 in the desired orientation within the neck 16.

In embodiments, as depicted in FIGS. 3 and 4, the lower/bottom surface of the rim 54 and/or annular skirt 58 may rest on the top surface of the partitions 50; and a radially inner portion of the annular skirt 58 may be configured to rest upon and interface with the upper surface of the container neck inner wall 16b so as to correctly set the position of the funnel 46 in the neck 16. The funnel 46 may also, in some embodiments (as depicted in FIGS. 3 and 4) include a second set of annularly spaced apertures or slots 74b, which—when the funnel is appropriately located within the neck 16—vertically align with the spaces 52b and together form part of a ‘breathing’ mechanism to be described below. In alternative embodiments a dedicated breathing channel may not be provided and, instead, breathing apertures may be provided in the top 20c of the cap 20 to allow gas pressure inside the device to equalise with the atmosphere.

The flow of the fluid sample within the fluidic device 1 according to embodiments of the present disclosure is illustrated in FIG. 3.

In use, the sample fluid is initially poured into the cylindrical receiving well 48 by the user, and the fluid sample is contained within the receiving well 48 and prevented from reaching the growth media 36 by the upper foil cover 40a. Subsequently, after the upper foil cover 40a (and lower foil cover 40b, when present) has been perforated or removed, the fluid sample can flow sequentially through the compartment 38 comprising the growth media 36, through the filter element 42, and into the main fluid reservoir 4 at the base of the container body 2.

In the event that the sample fluid level within the sample reservoir 48 reaches an overflow level, the excess fluid will be diverted via the slots 60 into the internal outflow chamber spaces 52a, which is a dead-end volume, and retained therein (see wide, grey arrows in FIG. 3). However, other convenient overflow mechanisms may alternatively be used. For example, in another embodiment, the funnel skirt 58 may extend radially inwards of the inner wall 16b and be arranged such that its lower surface is spaced axially above an upper edge of the inner wall 16b to create one or more circumferential channels/openings that communicate with at least one of the spaces 52a such that, if the sample loaded into the receiving reservoir 48 exceeds the volume defined by the inner wall 16b of the container neck 16 and the base of the receiving reservoir 48, the excess volume of sample fluid will flow over the upper edge of the inner wall 16b into the spaces 52a.

To reduce the possibility of inaccurate pouring of clinical sample, in use, a spill collection feature may be provided. Thus, in the depicted embodiment of FIGS. 1, 3 and 4, an annular channel or moat 63 is provided to capture fluid that may spill down the outer surface of the neck 16 and guide it into an external spill chamber 62 provided around the outer perimeter of the outer wall 16a radially between the outer wall 16a and an upstanding circumferential wall 62a. It will be appreciated that the spill chamber 62 may not and need not fully encircle the outer wall 16a; rather, the moat 63, which may fully encircle the outer wall 16a may drain spilt fluid into a spill chamber 62 which surrounds only a section of the outer wall 16a. As depicted in FIGS. 3 and 4, the annular moat 63 is conveniently created via the provision of a short, upstanding portion of the circumferential wall 62a which is concentric with and surrounds a lower section of the container neck 16. Thus, the circumferential wall 62a in these embodiments extends above the upper surface of the chamber 62 to create a partially enclosed channel. In alternative embodiments, such as the embodiments depicted in FIGS. 5A and 5B, the circumferential wall 62a does not include an upstanding circumferential projection and so the annular moat 63 is absent and this overflow feature may be omitted, or may be provided by an alternative fluid capture volume/spill chamber 62b radially outwards of the outer wall 16a of the neck 16. For example, in various embodiments of the disclosure, as depicted in FIG. 5B, the spill chamber 62b may be located in the space between the outer wall 16a of the neck 16 and the angled wall 25 on the radially inner surface of the cut-out segment 24. An opening (not depicted) in the top wall of the spill chamber 62b may be provided to allow spilt fluid to enter the spill chamber 62b.

FIGS. 5A and 5B show respectively an exploded perspective view of a fluidics device 1 according to another embodiment of the present disclosure, and a vertical cross-sectional view of the fluidic device 1 of FIG. 5A when the cap 20 is attached to (although not fully engaged with) the neck 16 of the container body 2, with like features identified by the same reference numerals as used in connection with the embodiment of FIGS. 3 and 4. FIGS. 5C and 5D show respectively exploded perspective views of fluidics devices 1 according to two further embodiments of the present disclosure, with same reference numerals used to depict like features.

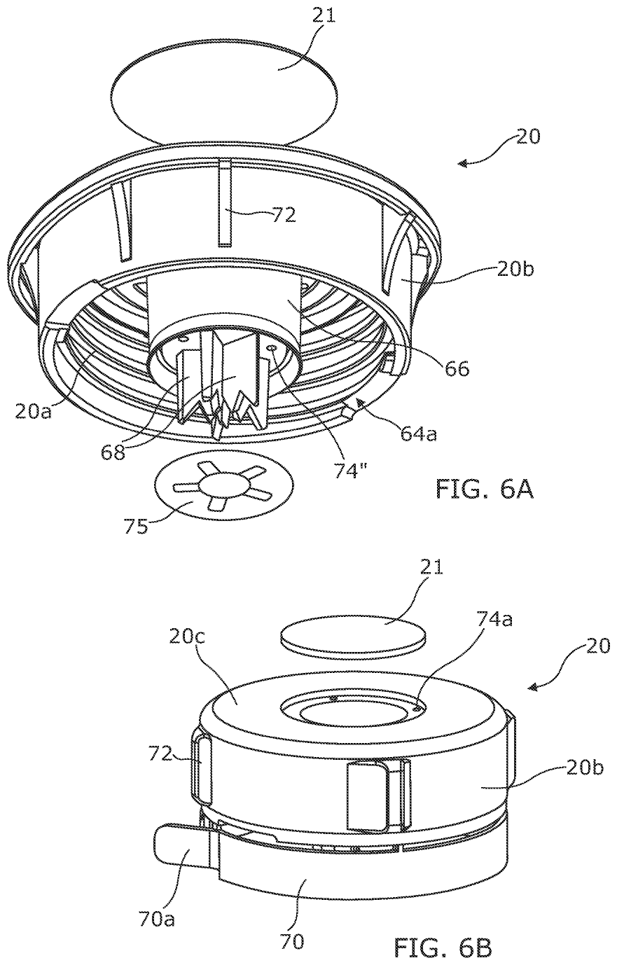

FIG. 6A illustrates a detailed exploded view of the cap 20 of FIGS. 5A and 5B, while FIG. 6B provides additional details of a cap 20 according to the embodiment of FIG. 4. FIG. 7A illustrates a detailed exploded view of the cap 200 of FIGS. 5C and 5D, while FIG. 7B provides additional details of the cap 200 when viewed from below.

As previously mentioned, the cap 20; 200 is sized and shaped to fit onto the container neck 16 and has an upper surface 20c configured to cover the internal volume of the neck 16, and a downwardly projecting annular wall 20b; 200b, the inner surface of which defines a plurality of female (inwardly projecting) threads 20a; 200a that are configured to be complementary to and engage with the external (male) threads 22a provided on the radially outer surface of the container neck outer wall 16a. Engagement between the threads 22a, 20a; 200a thereby allows the cap 20 to be screwed onto and secured to the container neck 16. To avoid the consumable from being reused, and/or minimise the risk of a potentially contaminated sample escaping the fluidics device 1 during or after use, a locking mechanism may be provided as a complementary feature pair, one of which features is provided on the cap 20; 200 and one of which is provided on the container body 2. In the depicted embodiments, the locking mechanism comprises a pair of complementary latch formations 64a, 64b—one on a lower inner surface of the cap 20 (64a, best shown in FIGS. 6A and 7B) and a corresponding one 64b on a lower portion of the outer surface of the outer wall 16a (feature 64b best shown in FIGS. 5A, 5C and 5D). The complementary latch features are suitably configured such that once the cap 20; 200 has been screwed down into its predetermined final position, the latch formations 64a, 64b engage with one another to lock the cap 20; 200 securely into place on the container neck 16.

As will be appreciated, it may be important to meter the volume of liquid sample that is used and, thus, loaded into the container body 2. For example, it may be desirable to mix a predefined volume/quantity of clinical sample with a predetermined quantity of growth media such that any bacteria can be grown optimally within the fluidics device 1 for analysis/assay. With this in mind, in the embodiment of FIGS. 4, 5B and 6A, so as to meter the volume of clinical sample mixed with media and loaded into the main fluid reservoir 4, the cap 20 comprises an inner cylindrical extension, plunger or plug 66 that is sized and shaped so as to form a substantially sealing fit within the cylindrical receiving well 48 provided in the container neck 16. In the depicted embodiment of FIGS. 5B and 6A, the plug 66 includes a resilient, outwardly projecting lip or skirt 66a, which forms a sealing contact with the inner surface of the receiving well 48. Furthermore, the depth of the plug 66 may conveniently be configured taking into account the cross-sectional area of the plug 66 (or receiving reservoir 48) such that when the cap 20 is screwed fully down into position on the container body 2, the plug 66 moves downwards into the receiving reservoir 48 by a distance that will displace a predetermined, desired volume of liquid sample out of the receiving reservoir 48 into the main fluid reservoir 4. In other embodiments, the plug 66 and skirt 66a may serve to aid the efflux of sample fluid from the receiving well 48 into the fluid reservoir 4, but may not have a defined ‘metering’ function. Alternatively, as depicted in the cap 200 embodiments of FIGS. 7A and 7B, a plug 66 is not provided on the underside of the cap 200. In these embodiments, liquid sample may be caused to flow from the receiving well 48 into the main fluid reservoir 4 through filter 42 under gravity, capillary and centrifugal force in use. In such embodiments, the amount of fluid that enters the main fluid reservoir 4 can be successfully controlled by the volume of the main fluid reservoir 4.

To control the time of mixing between a clinical sample and the growth media, as for example depicted in the embodiments of FIGS. 4 and 5A, a plurality of angled/pointed fins or projections 68 are formed on and extend from the underside of the cylindrical plug 66.

Alternatively, as depicted in the different embodiments of FIGS. 5C, 5D, 7A and 7B, a plurality of angled/pointed fins or projections 68 may be formed on and extend from the underside of the cap 200. Once the liquid sample has been loaded into the receiving reservoir 48 and the cap 20; 200 is screwed down onto the container neck 16, the projections 68 advance vertically downwards through the liquid receiving reservoir 48 and sample, and eventually will pierce the top foil cover 40a, thereby allowing sample fluid in the cylindrical receiving well 48 to enter the compartment 38 below and mix with the growth media 36. Further rotation and downwards movement of the cap 20; 200 will cause the projections 68 to subsequently pierce the bottom foil cover 40b, thereby allowing the mixture of fluid sample and growth media 36 to exit the compartment 38, pass through the filter element 42, and enter the main fluid reservoir 4 at the base of the container body 2. Beneficially, in the process of rotating the cap 20; 200 to screw it further down onto the container neck 16, the projections 58 also provide the additional function of agitating and/or stirring the sample fluid and growth media mixture (prior to piercing the bottom foil cover 40b), to help break up the growth media 36 into increasingly smaller particles and improve its mixability with and dissolution in the sample fluid. To this effect, the projections 68 may be shaped as blades or fins to improve mixing of sample fluid and media. Advantageously, the projections 68 are configured to scrape the sides of the growth media compartment 38 to further aid in mixing of the growth media 36 with the sample fluid by removing media that may be stuck to the walls of the chamber 38.

As the cap 20; 200 is advanced downwards over the neck 16 an increasing volume of liquid sample is pushed through the filter element 42 and into the main fluid reservoir 4. In order to ensure that the main fluid reservoir 4 is completely filled with liquid sample and that trapped air bubbles are avoided, it can be beneficial to provide an air/fluid release mechanism 52b; 74b in fluid communication with the main fluid reservoir 4. As the cap 20 of FIGS. 4 and 5B is screwed further downwards, liquid sample continues to fill the main fluid reservoir 4 by displacing air, which is enabled to escape from the container body 2 by passing upwards through filter element 42 and release chamber 52b and then out through the rim 54 of the funnel 46 via openings 74b. In order to ensure that all air has been displaced, it is advantageous to push more liquid sample into the main fluid reservoir 4 than is required to fill the volume of the reservoir 4. Excess liquid sample can also escape from the main fluid reservoir 4 via the same release mechanism 52b; 74b as air (described above). To this end, the bottom face of the chambers 52b (unlike the chambers 52a) is not closed. In addition, this release mechanism, serves to allow gas (air) to move back into the reservoir 4 when, in use, sample fluid is caused to move radially outwards from reservoir 4 to fill the fluidics systems 6 and, thus, avoid forming a vacuum in the reservoir 4, which would be detrimental to the operation of the fluidics system 6. The release mechanism therefore allows air pressure in reservoir 4 to equalise with atmospheric pressure.

In alternative embodiments, as depicted in FIGS. 5B and 6, there are no slots 74b in the funnel 46, and instead, a gas release mechanism is provided through the cap 20 via a series of apertures/orifices 74″ in the lower surface of the plug, which may conveniently be covered by a gas-permeable membrane 75 (see FIG. 6) to prevent escape of liquid. Alternatively, in any such embodiments, the end of the plug 66 may be entirely or partially formed by a gas permeable, fluid impermeable membrane, for example, to avoid the need to provide a plurality of individual orifices/breathing holes 74″. In such and similar embodiments, further orifices 74a (as shown in FIG. 7 depicting another embodiment of the cap 20) may be provided in the top surface 20c of the cap 20 to allow equalisation with atmospheric pressure. Such orifices may also be covered by a gas-permeable membrane 21.

In other alternative embodiments of the cap 200 and container body 2, as depicted in FIGS. 5C, 5D, 7A and 7B, for example, dedicated release chambers 52b with associated openings 74b may not be provided. Instead, a simpler mechanism for air escape and pressure equalisation is provided comprising one or more apertures (or orifices) 74a provided through the top of the cap 200 in communication with the sample receiving well 48 and main reservoir 4, such that air or other gas can escape directly from the receiving well 48. The one or more apertures 74a are conveniently covered with a hydrophobic filter/gas permeable membrane 75 in a similar way to that previously described. A further pressure release membrane 21 may also be provided over the hydrophobic membrane 75. In other embodiments, however, only one of membranes 75 and 21 may be present, which is sufficient to prevent unwanted movement of fluid. In some embodiments, for example, feature 21 may be a label.

Advantageously, in embodiments of the disclosure, the optional plug 66 and projections 68 of the cap 20; 200 are sized such that when the cap 20; 200 is fully engaged with and secured to the container body 2, the projections 68 do not reach/contact the filter 42; i.e. the tips of the projections 68 remain in the axial space between the bottom foil cover 40b and the filter 42 to avoid accidental piercing or puncturing the filter element 42, which would be undesirable.

To avoid a user accidentally piercing the film or foil lid 40a (when present) and exposing the media to the environment (with consequential risk of contamination) prior to intended use, a security (anti-fouling) measure 70 can be beneficially provided, as depicted in the embodiments of FIGS. 4 and 6B according to one embodiment, FIGS. 5A and 5B according to another embodiment; and FIG. 5C according to another embodiment. The security measure is suitably in the form of an annular spacer strip or collar 70 that (in the depicted embodiments of FIGS. 4 and 6B) is formed integrally with the lower, outer perimeter wall 20b of the cap 20; 200 and is configured to fit around the container neck 16. Thus, when the cap 20; 200 is engaged with the container neck 16, the collar 70 is located vertically below the cap 20; 200. As illustrated in FIG. 4, the width of the collar 70 is sized such that when the cap 20 is screwed down over the container neck 16, with the collar 70 in place, the collar 70 prevents the cap 20; 200 from being screwed down sufficiently far enough that the projections 68 protruding from the underside of the plug 66 could pierce the top foil cover 40a (or other cover element as may alternatively be provided). This mechanism thus ensures that the growth media 36 cannot be inadvertently exposed to the atmosphere and potential sources of contamination before use, and that the separation of the sample fluid and the growth media 36 is maintained until it is intended to perform the assay with the lid securely attached to the container body 2. Suitably, the assay device into which the fluidics device 1 is loaded in use may be configured not to accept and/or not to operate with a fluidics device 1 until the cap 20 has been fully engaged with the container body 2, for example, so that it can be ensured that the cap 20; 200 has fully sealed and is locked onto the container body 2 to appropriately contain any clinical sample.

Thus, in order to fully engage the cap 20; 200 and container body 2 to commence an assay, the collar 70 must be removed, for example, in the embodiments of FIGS. 4 and 6B, by pulling/tearing the collar from the wall 20b of the cap 20; 200. To this end, the collar may be provided with a pull-tab 70a for ease of grip/use. Advantageously, the join between collar 70 and cap side wall 20b is perforated or otherwise weakened to allow the collar to be removed without requiring significant force. For example, it is generally preferred that a user can remove the collar from the cap 20; 200 manually him/herself. Alternatively, as depicted in the embodiments of FIGS. 5A, 5B and 5C, the collar 70 may be provided separately from the cap 20; 200. This beneficially means that the collar 70 can be formed of a different material from the cap 20; 200 (if desired); for example, the collar 70 may be formed of a recyclable material such as cardboard. In addition, providing the collar 70 separately from the cap 20; 200 increases the ease with which the collar 70 may be removed by the user. Once the collar 70 has been removed from the cap 20; 200, the cap 20; 200 may then be securely attached to the container body 2 for normal use. Further, it should be noted that in the embodiments of FIGS. 5A and 5B, the moat upper wall 62a (and moat 62) is not present, which allows the collar 70 to be removed without having to first (partially) unscrew the cap 20.

It will be appreciated, however, that any other appropriate mechanism that may be envisaged by the skilled person for preventing undesirable, premature full engagement of the cap 20; 200 with the container body 2 may alternatively be used. Beneficially, such an alternative mechanism may allow the cap 20; 200 (if desired) to be retained on the container body 2 without the projections/blades 68 reaching through the sample receiving well/reservoir 48 sufficiently to pierce the upper cover 40a (or other cover as may be used) until it is desired to use the device.

As shown in FIGS. 6A, 6B. 7A and 7B, the outer circumferential wall 20b of the cap 20; 200 comprises a plurality of tabs or ridges 72 spaced radially about its circumference that improve the ability of a user to grip the cap 20; 200 when rotating the cap 20; 200 to secure it to the container neck 16. Notably, in the depicted embodiments, the top surface 20c of the cap 20; 200 comprises a series of through-openings/orifices 74a, covered by a pressure relief membrane 21, that serve as pressure vents. While in the embodiments of FIGS. 7A and 7B, the orifices 74a are additionally covered with a hydrophobic membrane 75. While the cap 20; 200 is being screwed downwards to secure it into position on the container neck 16, the openings 74a allow gas that is contained in the neck 16, chambers 52b and/or central reservoir 4 to escape the device 1 by different pathways according to embodiments of the disclosure. As described previously, according to the embodiment of FIGS. 3 and 4, gas release from the reservoir 4 proceeds via chamber 52b and vent opening 74b provided in the rim 54 of the funnel 46. Alternatively, according to the embodiment of FIGS. 5A, 5B and 6, gas release from the reservoir 4 and well 48 proceeds via vents/openings 74″ in the bottom surface of the plug or plunger 66, and the orifices 74a which are positioned so as to communicate with the volume radially inside the plug 66 (rather than radially outside of the plug 66) as in the embodiment of FIGS. 3 and 4. In yet another alternative, according to the embodiment of FIGS. 7A and 7B, gas release from the reservoir 4 and well 48 proceeds directly via orifices 74a through the top of the cap 200. Accordingly, together these openings 74a in the cap 20; 200 and/or funnel 46 or plug 66 help to regulate/release the pressure that may arise within the assembled device 1 during securing of the cap 20; 200 and after the cap 20; 200 has been secured in place.

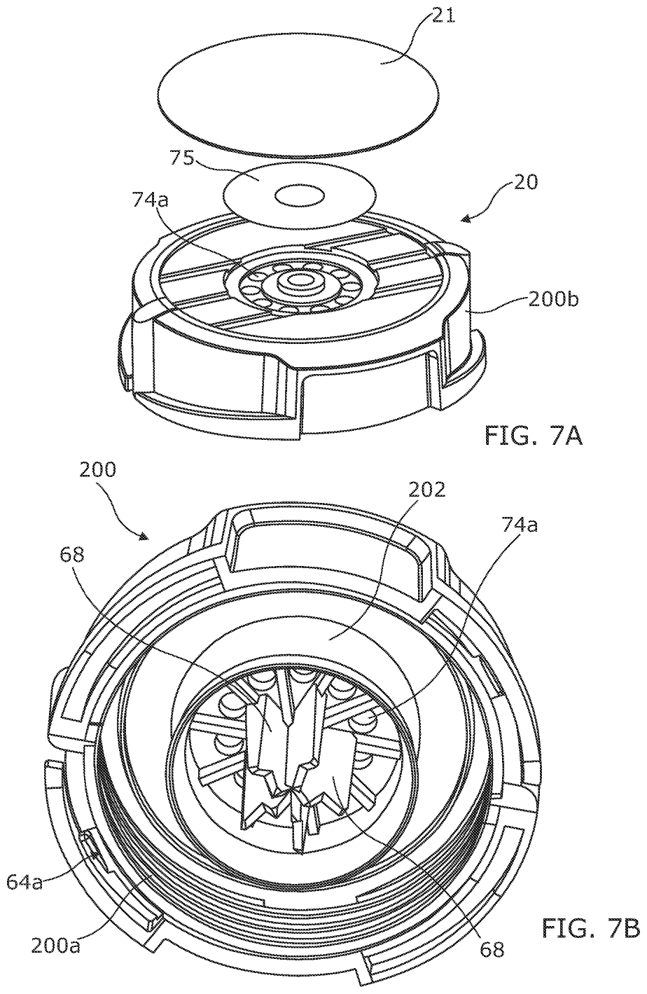

FIG. 8 shows a flow diagram illustrating various steps of a method 300 used to manufacture the fluidic device 1 comprising the container body 2 and the cap 20; 200. It is noted that a preferred method involves the separate manufacture of the cap 20; 200 and of the various components of the container body 2. Typically, all of these individual components are provided together as an assembled fluidics device 1 to the end-user. However, it is envisaged that certain component parts could be supplied separately or in separable form; for example, it may be possible to provide the media and/or filter components as a separate unit 43; 430 to allow for different clinical samples to be used and different assays to be performed.

In one suitable embodiment (depicted in FIG. 5A), the collar 70 is initially created and moulded as a separate element from the rest of the cap 20. In some embodiments, the collar 70 may instead be manufactured (e.g. by moulding) integrally with the rest of the cap as a removable (tear-off) strip to create the finished cap 20 in Step 305. The container body 2 may also be moulded using a specifically designed mould in Step 310. This step also involves the moulding of the individual fluidics systems 6 into the underside of the part of the substrate forming the radially outer portion 18 of the container body 2.

The capsule 43; 430 and the funnel 46; 460 are also manufactured separately by moulding at this stage.

Subsequently, the growth media 36 is placed within and sealed inside the capsule 43; 430 in Step 315. Conveniently, the bottom foil cover 40b is first sealed or welded in place within the capsule 43; 430; the growth media 36 is then deposited on top of the foil cover 40b; and the top foil cover 40a is finally sealed or welded into place to complete the compartment 38 and isolate the growth media 36 from the outside environment. The filter element 42 may then be sealed or welded into place below the bottom foil cover 40b in Step 320. Alternatively, in some embodiments, the individual elements contained in the capsule 43; 430 may instead be incorporated directly into the main container body 2 without requiring the creation of a separate capsule 43; 430 containing the growth media 6. In such embodiments, the bottom foil cover 40b is sealed or welded in place within the container neck 16; the growth media 36 is deposited on top of the foil cover 40b; and the top foil cover 40a is then sealed or welded into place to complete the compartment 38 and isolate the growth media 36 from the outside environment. The filter element 42 is again sealed or welded into place below the bottom foil cover 40b in Step 320. In some embodiments, as already noted, the growth media 6 may be provided as a powder or a concentrated liquid rather than a dried pellet or capsule. As the skilled person will appreciate, the capsule 43; 430 may be assembled in a different order to that set out above, and any alternative order of manufacture is intended to fall within the scope of the present aspects and embodiments. For example, as depicted in FIG. 5A, the capsule 43 may be placed in communication with the sample receiving well 18 from below; whereas as depicted in FIGS. 5C and 5D the capsule 430 may be positioned in the sample receiving well 18 from above. Desirably the manufacture of the capsule 43; 430 is performed under ‘clean’ conditions. In some embodiments, it may be preferred to manufacture the capsule 43 under ‘sterile’ conditions.

It will be appreciated that the cap 20; 200, container body 2 and fluidics systems 6, funnel 46; 460 and capsule 43; 430 can alternatively be manufactured in any appropriate manner, for example, by 3D printing/additive manufacturing, or by convenient combinations thereof.

The drugs/antibiotics that are to be tested are then deposited in Step 325 at their respective locations within each fluidic system 6 as appropriate (for example, within the fluid analysis chambers 12). Conveniently, in the end product at least the drugs/antibiotics are in dried form, e.g. as a result of having been initially deposited on the base of the fluid analysis chambers and dried thereon. This helps to ensure that the drugs will remain effective even if the sample container remains unused for an extended period of time (such as up to 2 years, up to 12 months, up to 6 months, or around 1 to 3 months). As the skilled person will appreciate, however, other forms/dosages of drug/antibiotic may be used according to preference or suitability—for example, the drug may be deposited onto a paper (e.g. a filter paper), which is placed in a region of the fluidic system 6 to be dissolved into the liquid sample, or the drug may be present in liquid form. Once all these individual elements—funnel 46; 460 and (if appropriate) growth media capsule 43; 430—have been created, the finished fluidics device is assembled by inserting the funnel 46; 460 into the neck of the container body 2 and the capsule 43; 430 into a receiving area in the underside of the container body 2, or the top side of the container body 2 in the embodiments of FIGS. 5C and 5D, in Step 335. After all of the individual components have been incorporated into the sample container body 2, the base cover 44 is sealed or welded to the bottom of the sample container body 2 in Step 335. It will be appreciated however that the funnel 46; 460 may in fact be inserted at a different stage in the process (for example, after the base cover 44 has been attached). Advantageously, the base cover 44 is a film/sheet material which can be sealed to the underside of the container body 2 by any convenient means, provided that a fluid-tight seal is formed around the edges of all channels and chambers of the fluidics systems 6 to prevent fluid from leaking out of the fluidics systems 6 in use. Proper sealing of the cover 44 to the container body 2 can be tested by any known procedure, for example, pressure testing. The final fluidics device 1 can then be assembled by combining the container body 2 and inserts with a respective cap 20; 200 and collar 70 and packaged (potentially as part of a larger batch of containers) ready for distribution in Step 340.

Optionally, in some cases, additional components may be included together with the packaging; these components may contain information relating to the corresponding batch of fluidic devices 1 and/or details of the analysis and processing that should be carried out subsequently. Such additional information may be stored in a form of memory stick, chip or RFID tag, as may be desired.

Once the end-user has been provided with the fluidic device 1 the sample fluid is transferred to and contained within the fluidic device 1 by: removing the cap 20; 200 and separating the collar 70 from the cap 20; 200 (either by removing the collar 70 from the neck 16 of the container body 2 where cap 20; 200 and collar 70 are formed separately, or from the cap 20 when formed integrally with the cap 20); pouring sample fluid into the container body 2 (i.e. into the receiving well 48) up to the desired (or indicated) level; and securing the cap 20; 200 in place over the neck 16 of the container body 2—the fluidic device 1 with sample housed therein may then be placed into an assay (diagnostic/test) device and be driven through a series of rotational motion phases to ensure that a well-mixed sample portion (containing an appropriate concentration of growth media 36 to promote bacteria growth) is distributed into each fluidic system 6, and a portion eventually retained with the respective fluid analysis chamber 12 for subsequent analysis. Such rotational motion would typically be driven using a motor or other programmable driving mechanism, with which the fluidic device 1 is operatively coupled, for example as part of a larger programmable analysis apparatus/device.

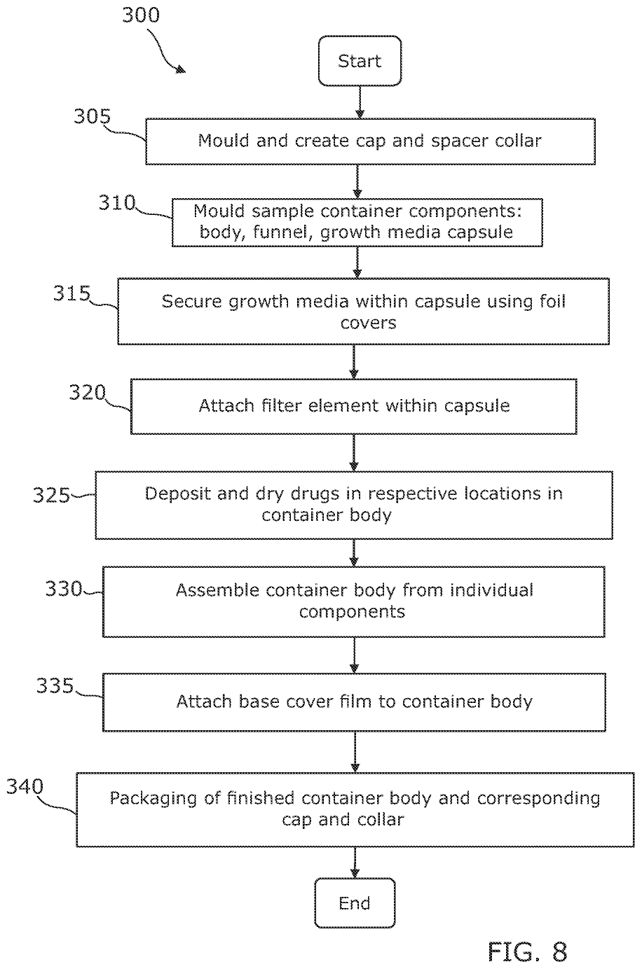

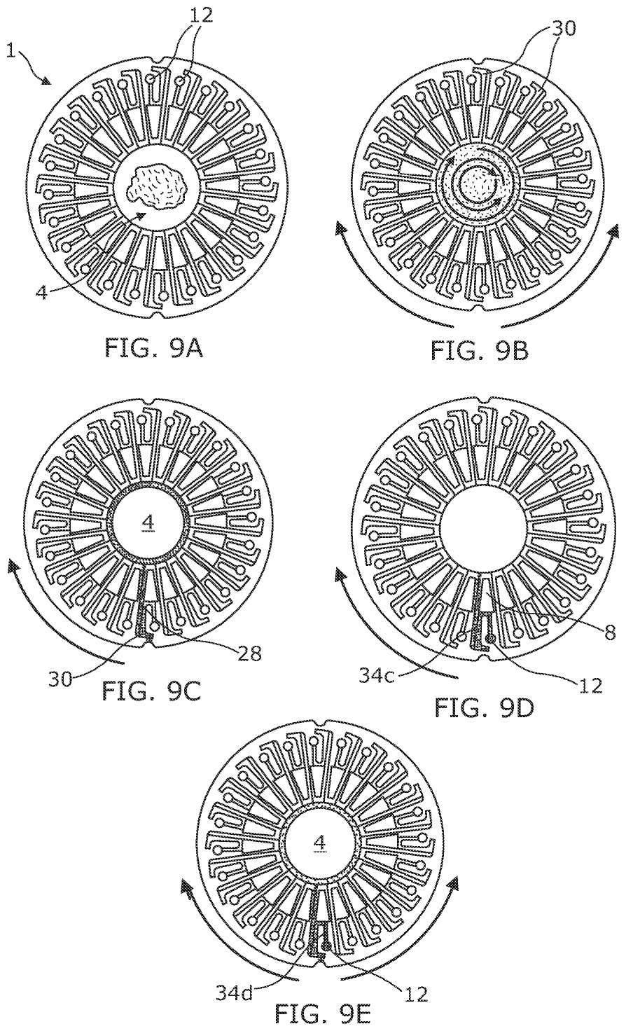

The various phases of the sample (re)distribution process for analysis of clinical samples will now be described with reference to the schematic snapshot plan-view diagrams of the sample container body 2 shown in FIGS. 9A to 9E, and the method 500 shown in the flow diagram of FIG. 10.

The process begins in Step 505 (see FIG. 10) when the fluid sample and growth media mixture have been located within the main fluid reservoir 4 by virtue of securing the cap 20; 200 to the container body 2; this stage is illustrated in FIG. 9A. An initial rotational ‘mixing’ phase is then carried out in Step 510 in which the fluidic device 1 undergoes reciprocal or oscillatory rotation—alternate clockwise and anticlockwise rotation of the sample container is driven, at a first speed (for example, at about 250 rpm up to about 1,500 rpm; e.g. at about 500 rpm) and for a first duration (typically about 30 seconds to 1 minute, up to about 10 minutes), so as to promote thorough inertial mixing and dissolution of the growth media 36 in the fluid sample; this process is illustrated in FIG. 9B. For example, 5 reciprocal cycles may be performed for 5 seconds in each direction for 5 repeats.

Once the growth media 36 has been sufficiently mixed and dissolved within the fluid sample, a second phase providing a distribution and clarifying rotation is implemented in Step 515 where the fluidic device 1 is rotated in one direction (clockwise in the illustrated embodiment) at a second higher rotational speed (up to between about 1,800 to 3,000 rpm) for a second duration (for example, from about 10 to 30 seconds). In embodiments the clarifying spin may be at a speed of about 2,600 rpm for about 15 seconds. This rotational motion results in the generation and application of centrifugal force to the fluid sample in the main fluid reservoir 4, forcing the fluid sample to flow radially outwards along the respective first fluidic channels 28 and into the associated separation chambers 30 of each fluidics system 6. Prolonged rotation during this phase in Step 520 will allow the fluid samples present in the respective separation chambers 30 to clarify as larger particulate matter sediments at the radially outer edge thereof. The speed of rotation in this phase is selected to balance the force on the fluid pushing it further inwards from the separation chamber 30 and the pressure force exerted by the compressed gas within the valve mechanism (air spring) 8, which prevents the fluid sample from overflowing the associated weirs 30a and entering the respective first channel arms 32c of the second fluidic channels 32; as illustrated in FIG. 9C. Next, the sample container is rotated in a third phase, at an even higher speed (above 1,900 rpm, for example, between about 2,800 and 4,500 rpm) for a third duration (about 10 to 30 seconds) in Step 525. In embodiments, this analysis chamber filling spin may be at a speed of about 4,000 rpm for about 15 seconds. It will be appreciated, however, that the selected rotational speed may be tailored to the particular valve mechanism 8 (e.g. the volume of the air spring), which dictates the force that it required to push the clarified fluid sample past the valve mechanism 8. The centrifugal force generated as a result of this higher rotational motion drives substantially all of the remaining fluid sample present in the main fluid reservoir 4 into the individual fluidics systems 6; in turn, this displaces the clarified fluid that was already present in the separation chambers 30 further (radially inwardly) into the first channel arms 32c of the second fluidic channels 32. A pressure is thereby exerted by the fluid filling the first channel arms 32c on the valve mechanism 8, which is sufficiently high to enable the contrary pressure exerted by the compressed gas contained within the valve mechanism storage chambers to be overcome; the fluid sample may then pass into the second channel arms 32d and thereafter into each of the fluid analysis chambers 12. This is illustrated in FIG. 9D.

At the end of the third duration, enough fluid has passed through the respective valve mechanisms 8 to fill the associated fluid analysis chambers 12 (with gas previously present in the analysis chambers 12 pushed out and back to the valve mechanism/air spring 8. At this stage, the rotational motion may be reduced—in any of the aspects and embodiments described in this disclosure—in Step 530 to a fourth speed (e.g. from about 3,000 rpm to between about 1,300 rpm and 1,500 rpm). At this speed the gas within the valve mechanism 8 is able to expand and once again provides sufficient pressure to overcome the movement of fluid from the separation chamber 30 radially inwardly, and thus creates a physical gas barrier between fluid on the first (separation chamber 30) side of the valve 8 and fluid on the second (analysis chamber 12) side of the valve 8—as illustrated in FIG. 9E. At this stage, depending on the solubility of the drugs to be tested in the fluid samples, the samples in the analysis chambers 12 may then be ready for testing. Alternatively, an intermediate (fourth) rotational process may be implemented to encourage thorough mixing with and dissolution of the drug/antibiotic (stored within the analysis chamber 12) in the fluid sample. By way of example, the fluidic device 1 may be once again rotated alternately clockwise and anticlockwise at this fourth speed and for a fourth duration (e.g. of around a few minutes). This periodic reversal of rotational direction correspondingly changes the direction of fluid movement and thereby promotes inertial mixing of the fluid sample with the respective drug that has been deposited (in this embodiment) within the fluid analysis chambers 12 (FIG. 9E). Of course, in some uses control samples are not exposed to an antibiotic or other drug in the analysis chamber 12. In any of the embodiments described herein, it has been found that by approximately matching the width of the analysis chamber with the depth of the analysis chamber (e.g. by configuring the analysis chamber to have a width of approx. 4 mm and a depth of approx. 4 mm) inertial mixing may be improved; especially in conjunction with a cylindrical-shaped well. Typically, the analysis chamber may have a width and depth of between about 3 mm and about 8 mm, depending on the desired volume to be tested and the desired size of the device 1. Beneficially the width and depth are approximately the same length.

After the fluid samples have been suitably mixed with their respective drug, the analysis stage may be implemented in Step 535 in which the individual (drug-dosed) sample portions in each of the fluidics systems 6 are analysed by exposing them to a source of light and the amount of light scattering caused by particulate matter—such as bacteria present in each sample—is measured or simply detected as a function of time. Changes in the amount of light scatter by a sample, and specifically decreases in light scatter over time, may be indicative of the amount (e.g. concentration) of particulate matter—especially bacteria—present in the fluid samples and so, beneficially, a reduction in the amount of light scatter detected can indicate the susceptibility of the relevant bacterial strain present in the sample to the drug, or to the concentration of the drug, used to dose that sample. The relative susceptibility of the bacteria in a given sample to different types and concentrations of drugs can be ascertained by using the above-described fluidic device 1 and method 300, whereby each type and/or concentration of drug to be tested is provided in a different one of the fluidic systems 6. In some embodiments the amount of light scatter may be proportional to the relative or even the absolute concentration of bacteria in a sample; and may be determined by an appropriate algorithm based on the amount of light scattered.

In one embodiment, for example utilising the fluidic device 1 illustrated in FIGS. 1 to 5D, the container body 2 may comprise 19 individual fluidic systems 6. This would allow any number of different tests up to 19 to be performed. In some embodiments, one particular drug may be tested against the same fluid sample multiple times, e.g. at a range of different concentrations in the respective analysis chambers 12. In other embodiments a plurality of different drugs may be tested against the same fluid sample, each at one or more test concentrations. Negative and positive test comparisons may also be provided. For example, providing up to 19 test wells may allow for the following tests to be performed: (a) 5 or 6 different drugs (or drug mixtures) at up to 3 different concentrations each; (b) 7 or 8 different drugs (or drug mixtures) at up to 2 different concentrations each; or (c) various drugs (or drug mixtures) at various different concentrations each. In each of these three cases, a minimum of 1 control systems and preferably at least 2 control systems (e.g. fluidics systems without any drugs present—typically one positive control containing no drugs, and one negative optical control where the chamber is rendered optically opaque) can be retained for comparison purposes. In other embodiments, a biological negative control may be included instead of or in addition to the optical negative control, e.g. by depositing a bactericidal chemical such as triclosan into one of the fluidic systems. In summary, the effects on one clinical sample of up to 18 different drugs/drug dosages can be tested using each fluidic device 1. It will be understood that the particular drugs to be tested, and the particular drug concentrations to be tested may depend on the country/territory in which the device is to be used and/or on the suspected medical indication and likely bacterial infections to be screened.

In another embodiment, for example utilising the fluidic device 1 illustrated in FIGS. 9A to 9E, the sample container may comprise 24 individual fluidics systems (for example, in this embodiment the container body base forms a complete circle without any segments or cut-outs). In this instance, 3 different concentrations of up to 7 different drugs may be tested, whilst still maintaining up to 3 control systems for comparison. In other words, the effects on one clinical sample of up to 23 different drug dosages (or even more if fewer control systems are used) can be tested using each fluidic device 1.

Alternatively, the size of the sample container may instead be reduced even further, and the container body 2 may comprise as few as 16 or even 8 individual fluidic systems 6. Such a container would occupy less physical space, but would of course mean that a smaller range of drug dosages (i.e. fewer drug types and/or concentrations) could be tested. Such a device could be beneficial for more targeted testing and analysis while reducing the use and disposal of plastic materials, for example.

It will be appreciated that the selection of drugs and drug concentrations can be made by the skilled person according to the intended end use of the device. In particular implementations where the fluidic device 1 is to be used to test clinical samples comprising urine of a patient or subject, and specifically where the fluidic device 1 is used to determine the most appropriate drug to use for treatment of a urinary tract infection (UTI), the drugs/antibiotics deposited in the fluidic device 1 may be selected from one or more of the group comprising: Ciproflaxacin HCl monohydrate (CIP); Phosphomycin Disodium Salt (FOS); Mecilinam Hydrochloride (MEC HCl); Nitrofurantoin Sodium (NIT); Trimethoprim Lactate (TMP); and Sulfamethaxazole Sodium (SXT). Suitably, the antibiotic is selected from one or more of the group consisting of the above-mentioned antibiotics.

In preferred embodiments, the drugs/antibiotics deposited in the fluidic device 1 for use in assessing the drug sensitivity of bacteria present in a suspected UTI may be selected from one or more of the group comprising: the Amoxicillin; Amoxicillin/clavulanic acid (2/1); Cefalexin; Ciprofloxacin; Ertapenem; Fosfomycin; Levofloxacin; Mecillinam; Nitrofurantoin; Trimethoprim; Trimethoprim/sulfamethoxazole (1/19). Suitably, the antibiotic is selected from one or more of the group consisting of the above-mentioned antibiotics.

Possible bacteria that may be associated with UTIs and against which the assay may be performed include the following: E. coli; P. aeruginosa; S. aureus; Beta Streptococcus; Staphylococcus and P. aeruginosa. Since more than one such bacteria may be present in a sample, and different bacteria may have different antibiotic sensitivities, it is advantageous to include the range of relevant antibiotics at a range of relevant amounts so as to result in the appropriate range of relevant antibiotic concentrations in the fluid sample to be assayed in the analysis chamber 12 of the device 1.

Beneficially, a plurality of antibiotics is used in the fluidic device 1 and methods of this disclosure: for example, between 2 and 18, between 2 and 15, or between 3 and 12, such as 4, 5, 6, 7, 8, 9, 10 or 11 different antibiotics and/or antibiotic combinations. Beneficially, each of the one or more antibiotics is provided in a plurality of predetermined different quantities in each of the fluidic systems 6, such that once dissolved in the liquid sample a desired range of antibiotic concentrations is achieved in each analysis chamber 12 for testing. Generally, each separate fluidic system 6 contains only one antibiotic at the preselected quantity such that each test sample contains only one antibiotic at a known concentration. However, it can be envisaged that in some assays it may be desirable to provide two or more antibiotics in preselected amounts (to produce desired concentrations in the same test sample), e.g. to test the efficacy of multi-drug assays against certain bacteria—for example, as may be therapeutically indicated for treatment of a particular infection.

The effectiveness of an antibiotic may be assessed based on a measurement of the Minimum Inhibitory Concentration (MIC), which is the lowest concentration of an antibiotic required to inhibit the growth of an organism. The skilled person is able to readily obtain the MIC of a particular antibiotic for a particular bacteria. For example, in one simple method the bacteria are added to plates containing varying concentrations of the antibiotic. The concentration of antibiotic is doubled in each successive plate, and the MIC is found by identifying the first plate in which there is no visible colony after an incubation period. In preferred embodiments, the above antibiotics, when used, may be deposited in the necessary quantity to provide a predetermined concentration of drug dissolved in the fluid sample within each analysis chamber 12 in the range of approx. 1× to 5× MIC, in the range of approx. 1× to 3× MIC, or in the range of approx. 1× to 2× MIC. However, different concentrations may alternatively be used in order to take account of the assay conditions, including sample type and fluidic/assay system.

Alternatively, the amount of antibiotic deposited in each fluidic system 6 may be selected to provide a concentration of dissolved antibiotic in the fluid sample within each analysis chamber that is equal to or determined as a multiple of the bacterial ‘breakpoint’ for the selected drug. A breakpoint is a chosen concentration (mg/L) of an antibiotic which defines whether a species of bacteria is susceptible, intermediate or resistant to the antibiotic. If the MIC is less than or equal to the susceptibility breakpoint the bacteria is considered susceptible to the antibiotic. If the MIC is greater than this value, the bacteria is considered intermediate or resistant to the antibiotic. Thus, although breakpoints can be considered to be discriminatory antimicrobial concentrations used in the interpretation of results of susceptibility testing, the value of the breakpoint may be set according to clinical, pharmacological, microbiological and/or pharmacodynamic considerations, which factors are under frequent assessment and so may vary from time to time or according to the relevant territory. For example, European breakpoints are set by the European Committee on Antimicrobial Susceptibility Testing (EUCAST), while breakpoints in the US are set by the Clinical Laboratory Standards Institute (CLSI). The EUCAST and CLSI breakpoints are different for certain antibiotics and certain bacterial species and, therefore, embodiments of the disclosure are directed to providing fluidic devices 1 for use in the US (and other territories) in accordance with the CLSI standards; and other embodiments of the disclosure are directed to providing fluidic devices 1 for use in Europe (and other territories) in accordance with the EUCAST standards. Some embodiments of the disclosure relate to fluidic devices 1 which may be suitable for use in both Europe and the US, by providing appropriate amounts of antibiotics to conform with the differing standards of each system. It is important to appreciate that MIC and breakpoint concentrations are standardised for individual organisms by CLSI and EUCAST and are based on testing antibiotics in synthetic media against bacteria isolated by culture from clinical samples. However, the devices and methods of the present disclosure are not typically used under such ‘ideal’ conditions. Thus, in other embodiments antibiotic amounts to be introduced into the fluidic devices of this disclosure (and resultant concentrations) are selected based on the results of assays (which assays are within the capabilities of the skilled person) to determine the active concentration or amounts of each relevant antibiotic (or other drug) under the expected conditions of the test. For example, to determine suitable concentrations of the antibiotics of interest, trial and error tests may be performed within a medium of clinical urine, and optionally within a microfluidic system according to this disclosure. In this way, the amount of antibiotic (or other drug) to be deposited into the fluidics devices of this disclosure may suitably be that/those which exhibit the activity of most interest in the intended sample type. A range of antibiotic amounts/concentrations can thus be determined—that may be different to the predicted values based on EUCAST or CLSI breakpoints—which are expected to identify and discriminate between the activity of interest in the biological sample of interest. In addition, combinations of antibiotics or other drugs may be combined and tested similarly, in order to identify an effective combination and concentration of antibiotics or drugs.

Embodiments of the disclosure are therefore directed to a fluidic device 1 according to any of the aspects and embodiments described herein, which comprises within at least one fluidic system 6 an amount of an antibiotic selected from Amoxicillin, Amoxicillin/clavulanic acid (2/1), Cefalexin, Ciprofloxacin, Ertapenem, Fosfomycin, Levofloxacin, Mecillinam, Nitrofurantoin, Trimethoprim, and Trimethoprim/sulfamethoxazole (1/19) in a quantity sufficient to achieve a desired antibiotic concentration between e.g. 1× and 5× the bacterial breakpoint dissolved within a fluid sample in the analysis chamber 12. In some embodiments, the quantity of antibiotic is sufficient to achieve a desired antibiotic concentration between 1× and 3×, between 1× and 2× and suitably 1×, the bacterial breakpoint dissolved within a fluid sample in the analysis chamber 12. Preferably, the fluidic device 1 comprises at least 3, at least 5, at least 7, at least 9, or at least 11 different antibiotics (or antibiotic combinations) selected from those listed above, wherein each fluidic system 6 of the device 1 contains at most one of the above listed antibiotics or antibiotic combinations. The quantities of antibiotics listed above may be defined according to the EUCAST and/or the CLSI standards. Tables 1 and 2 below indicate exemplary target concentrations to be achieved by the amount of each antibiotic used in fluidic devices according to the present disclosure.

TABLE 1
Target concentrations of each antibiotic to be achieved in a fluid sample within an analysis chamber 12 of
a device 1 according to the present disclosure as adapted for use in CLSI adopting countries. A device 1
according to the disclosure may comprise one or more of the antibiotics listed in the left-hand column
(column 1), and/or may comprise one or more of the amounts of each antibiotic required to result in a
dissolved antibiotic concentration as listed in any of columns 4 to 7.

| | CLSI | | | | | |
|---|---|---|---|---|---|---|
| | concentration | | Target concentration in | | | |
| Antibiotic | (mg/L) | Bacteria | each analysis well (mg/L) | | | |
| Amoxicillin | 8 | E. coli | 8.0 | 12 | 16 | 24 |
| Amoxicillin/Clavulanic | 8 | E. coli | 8.0 | 12 | 16 | 24 |
| acid (2/1) | | | | | | |
| Cefalexin | 16 | E. coli | 16 | 24 | 32 | 48 |
| Ciprofloxacin | 0.25 | E. coli | 0.25 | 0.375 | 0.50 | 0.75 |
| Ciprofloxacin | 0.5 | P. aeruginosa | 0.5 | 0.75 | 1.0 | 1.5 |
| Ciprofloxacin | 1 | S. aureus | 1.0 | 1.5 | 2.0 | 3.0 |
| Ertapenem | 0.5 | E. coli | 0.5 | 0.75 | 1.0 | 1.5 |
| Ertapenem | 1 | Beta | 1.0 | 1.5 | 2.0 | 3.0 |
| | | Streptococcus | | | | |
| Fosfomycin | 64 | E. coli | 64 | 96 | 128 | 192 |
| Levofloxacin | 0.5 | E. coli | 0.5 | 0.75 | 1.0 | 1.5 |
| Levofloxacin | 1 | Staphylococcus | 1.0 | 1.5 | 2.0 | 3.0 |
| | | and P. aeruginosa | | | | |
| Levofloxacin | 2 | Beta | 2.0 | 3.0 | 4.0 | 6.0 |
| | | Streptococcus | | | | |
| Mecillinam | 8 | E. coli | 8.0 | 12 | 16 | 24 |
| Nitrofurantoin | 32 | E. coli | 32 | 48 | 64 | 96 |
| Trimethoprim | 8 | E. coli | 8.0 | 12 | 16 | 24 |
| Trimethoprim/ | 2 | E. coli | 2.0 | 3.0 | 4.0 | 6.0 |
| Sulfamethoxazole | | | | | | |
| (1/19) | | | | | | |

TABLE 2
Target concentrations of each antibiotic to be achieved in a fluid sample within an analysis chamber 12 of a device
1 according to the present disclosure as adapted for use in EUCAST adopting countries. A device 1 according to
the disclosure may comprise one or more of the antibiotics listed in the left-hand column (column 1), and/or may
comprise one or more of the amounts of each antibiotic required to result in a dissolved antibiotic concentration as
listed in any of columns 4 to 7.

| | EUCAST | | | | | |
|---|---|---|---|---|---|---|
| | concentration | | Target concentration in | | | |
| Antibiotic | (mg/L) | Bacteria | each analysis well (mg/L) | | | |
| Amoxicillin | 4 | E. coli | 4.0 | 8.0 | 12 | 16 |
| Amoxicillin/Clavulanic | 4/2 | E. coli | 4.0/2.0 | 8.0/4.0 | 12/6.0 | 16/8.0 |
| acid (2/1) | | | | | | |
| Cefalexin | 16 | E. coli | 16 | 24 | 32 | 48 |
| Ciprofloxacin | 0.25 | E. coli | 0.25 | 0.375 | 0.50 | 0.75 |
| Ciprofloxacin | 1 | P. aeruginosa | 1.0 | 1.5 | 2.0 | 3.0 |
| Ciprofloxacin | 4 | S. aureus | 4.0 | 6.0 | 8.0 | 12 |
| Ertapenem | 0.5 | E. coli | 0.5 | 0.75 | 1.0 | 1.5 |
| Fosfomycin | 32 | E. coli | 32 | 48 | 64 | 96 |
| Levofloxacin | 0.5 | E. coli | 0.5 | 0.75 | 1.0 | 1.5 |
| Levofloxacin | 1 | Staphylococcus | 1.0 | 1.5 | 2.0 | 3.0 |
| | | and P. aeruginosa | | | | |
| Levofloxacin | 4 | Beta | 4.0 | 6.0 | 8.0 | 12.0 |
| | | Streptococcus | | | | |
| Mecillinam | 8 | E. coli | 8.0 | 12 | 16 | 24 |
| Nitrofurantoin | 64 | E. coli | 64 | 96 | 128 | 192 |
| Trimethoprim | 2 | E. coli | 2.0 | 3.0 | 4.0 | 6.0 |
| Trimethoprim/ | 1 | E. coli | 1.0 | 1.5 | 2.0 | 3.0 |
| Sulfamethoxazole | | | | | | |
| (1/19) | | | | | | |
| Trimethoprim/ | 2 | E. coli | 2.0 | 3.0 | 4.0 | 6.0 |
| Sulfamethoxazole | | | | | | |
| (1/19) | | | | | | |

With reference to Tables 1 and 2 above, the skilled person will appreciate that a device 1 may comprise one or more antibiotics in amounts intended to give two or more of the concentrations listed in columns 4 to 7 for each particular antibiotic. In other embodiments, a device 1 may comprise a plurality of antibiotics (or antibiotic combinations) as listed in column 1, in one or more amounts intended to give one or more of the concentrations listed in columns 4 to 7 for the respective antibiotics.

In some embodiments, fluidic devices 1 according to the disclosure comprise 16 test microsystems 6, each of which comprises, respectively, the antibiotic (or antibiotics) listed in Table 3, column 1 (below) in an amount suitable to provide a concentration of antibiotic in each respective analysis chamber 12 equal to the CLSI concentration listed in Tables 3, column 3; or the EUCAST concentration listed in Table 3, column 4.

TABLE 3
Exemplary antibiotics and target concentrations of each antibiotic to be
achieved in a fluid sample within a respective analysis chamber 12 of a
device 1 according to the present disclosure as adapted for use in CLSI
adopting countries (column 3) or EUCAST adopting countries (column 4).

| | | Target concen- | Target concen- |
|---|---|---|---|
| | | tration for CLSI | tration for EUCAST |
| Antibiotic | Bacteria | standard (mg/L) | standard (mg/L) |
| Amoxicillin | E. coli | 8 | 4 |
| Amoxicillin/ | E. coli | 8 | 4/2 |
| Clavulanic | | | |
| acid (2/1) | | | |
| Cefalexin | E. coli | 16 | 16 |
| Ciprofloxacin | E. coli | 0.25 | 0.25 |
| Ciprofloxacin | P. aeruginosa | 0.5 | 1 |
| Ciprofloxacin | S. aureus | 1 | 4 |
| Ertapenem | E. coli | 0.5 | 0.5 |
| Ertapenem | Beta | 1 | N/A |
| | Streptococcus | | |
| Fosfomycin | E. coli | 64 | 32 |
| Levofloxacin | E. coli | 0.5 | 0.5 |
| Levofloxacin | Staphylococcus | 1 | 1 |
| | and P. | | |
| | aeruginosa | | |
| Levofloxacin | Beta | 2 | 4 |
| | Streptococcus | | |
| Mecillinam | E. coli | 8 | 8 |
| Nitrofurantoin | E. coli | 32 | 64 |
| Trimethoprim | E. coli | 8 | 2 |
| Trimethoprim/ | E. coli | N/A | 1 |
| Sulfameth- | | | |
| oxazole (1/19) | | | |
| Trimethoprim/ | E. coli | 2 | 2 |
| Sulfameth- | | | |
| oxazole | | | |
| (1/19) | | | |

Fluidic devices 1 according to embodiments of the present disclosure (e.g. as set out in Table 3) may preferably comprise additional fluidic systems 6 providing one or more positive and/or one or more negative control for assaying bacterial growth or background levels of light scatter. For example, a positive control fluidic system 6 may comprise no antibiotic for demonstrating the rate of bacterial growth in the fluid sample within inhibition/under optimal growth conditions. Negative control fluidic systems 6 may comprise an opaque surface over the analysis chamber to prevent light from passing through the analysis chamber 12 and potentially being collected as scattered light; and/or may comprise a bactericidal (or bacteriostatic) agent within the microfluidic chamber (e.g. triclosan), to prevent bacteria from multiplying.

While the above Tables 1 to 3 set out some exemplary embodiments and concentrations of antibiotics that may be used in accordance with the present disclosure, it will be appreciated—as described above—that other known antibiotics and/or concentrations of any such antibiotics may be used in accordance with the present disclosure: for example, those that have been determined to exhibit desirable or beneficial results in the system/under the conditions of interest.

An implementation example will now be described in which the fluidic device 1 is used in a device comprising an optical analysis apparatus to process clinical samples, and to determine drug susceptibility of the bacteria in those samples by measuring changes in light scatter within the sample, which—in accordance with the invention—is indicative of corresponding changes in bacterial number or concentration as a function of time.

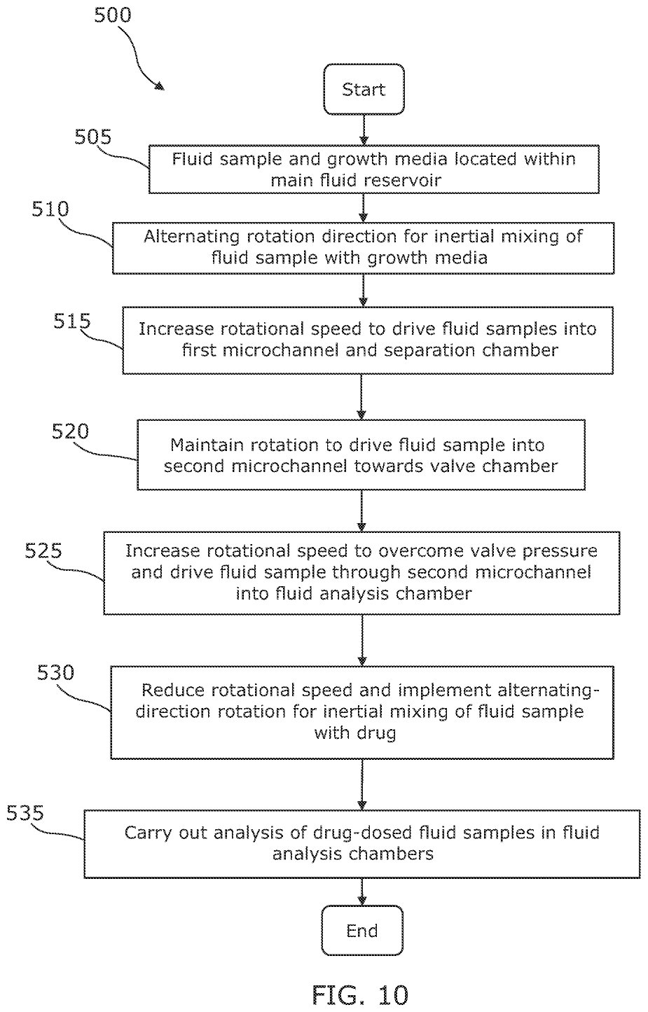

FIGS. 11 to 15 show details of an exemplary optical analysis apparatus that may be used for this purpose. A general description of this apparatus will be provided here; further details of this apparatus may also be found in the Applicant's co-pending application titled “Apparatus, System and Method for Measuring Properties of a Sample” (see e.g. GB 2001397.5).

FIG. 11 shows a vertical cross-sectional diagram of a device or apparatus 1101 comprising an optical arrangement 1102 and a sample positioning mechanism 1104. These two components are configured to interact with the fluidic device 1 containing the clinical sample under analysis to enable the above-mentioned bacterial concentration determination to be carried out.

The sample positioning mechanism 1104 is configured to engage with and support the fluidic device 1, and to optically couple or link at least a portion of the fluidic device 1 with components of the optical apparatus 1102. In more detail, the sample positioning mechanism 1104 comprises a sample carousel or sample carrier 1108, and an operatively-coupled motor 1110, for example a BLDC (Brushless DC) motor or other similar driving mechanism, which controls rotation of the sample carousel 1108 (and thereby rotation of the engaged fluidic device 1). In use, when the fluidic device 1 and the optical apparatus 1102 are optically coupled, the optical apparatus 2 is configured to illuminate the portions of the clinical sample contained within the fluid analysis chambers 12 of the fluidic device 1. The optical apparatus 1102 is also configured to detect and measure light scattered by bacterial particles in the illuminated clinical sample portion. The detected scattered light intensity may then be analysed to ascertain properties of the bacteria in the sample, in particular the bacterial concentration (relative concentration of cell division/growth rate) in the sample as a function of time.

The device 1101 comprises an outer casing or housing 1112 that contains the other components within it. In the illustrated embodiment, the housing 1112 comprises a base 1112a upon which the other device components are mounted; front 1112b and rear 1112c body portions that provide the walls of the housing 1112; and a movable/detachable lid 1112d. In the illustrated embodiment, the lid 1112d is hingedly attached to the rear body portion 1112c; although, of course, other attachments mechanisms and locations may be used. The lid 1112d, together with the body portions 1112b, 1112c and the base 1112a, form an enclosure that contains within it the various device components when the device 1101 is in use. It will however be appreciated that the various portions of the housing 1112 may instead be provided in more or fewer parts than have been illustrated herein. The device 1101 further comprises a closure/securing mechanism 1113 that is used to maintain the lid 1112d in a closed, locked position, for example after the fluidic device 1 has been inserted into its intended position within the device 1101 and engaged with the sample carousel 1108. The closure mechanism 1113 comprises, in various embodiments, an actuator 1113a positioned within the device housing 1112 that may be programmably actuated in the event that the lid 1112d is to be opened.

The device 1101 further comprises a temperature control module or arrangement 1114 that is configured to maintain the temperature within the housing 1112, and particularly in the region surrounding the fluidic device 1, within a preferred temperature range (e.g. around 36 to 38°, preferably between about 36 to 37°, such as about 37°). This temperature range is particularly desirable to promote and maintain the growth of the bacteria within the clinical sample at optimal growth conditions. In addition, the illustrated device also comprises a user interface 1115 such as an interactive touchscreen display, via which a user of the apparatus 1101 may interact with and program various aspects of the apparatus 1101; view certain results; and/or monitor the progress of the analysis process. For example, details to allow identification of the patient or subject may be entered by the user; measurement parameters may be displayed and altered using the interface; software updates for the apparatus 1101 may also be downloaded via interaction of the user with the user interface 1115; measurement progress and various intermediate and end-results may also be displayed to the user via the user interface 1115. Additionally, the user interface 1115 may be used to provide instructions to the user to guide them through the various steps in the process of loading a sample into the fluidic device 1, and subsequently of correctly engaging the fluidic device 1 with the sample carousel 1108. For example, the user interface 1115 may instruct the user to perform the following steps: (i) remove the cap 20; (ii) remove the collar 70; (iii) pour the sample into the receiving well 48; and (iv) screw on the cap 20. Finally, the apparatus 1101 comprises one or more processors or processing units 1116 that provide programmable control of the various device components (e.g. the optical apparatus 1102, the sample positioning mechanism 1104 the lid closure mechanism 1113, and/or the user interface 1115).

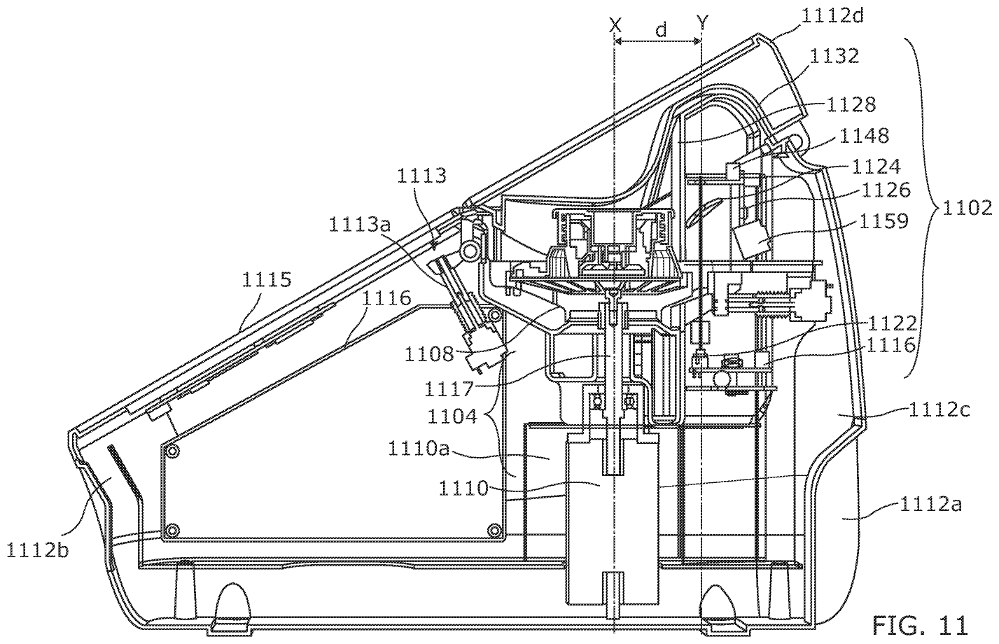

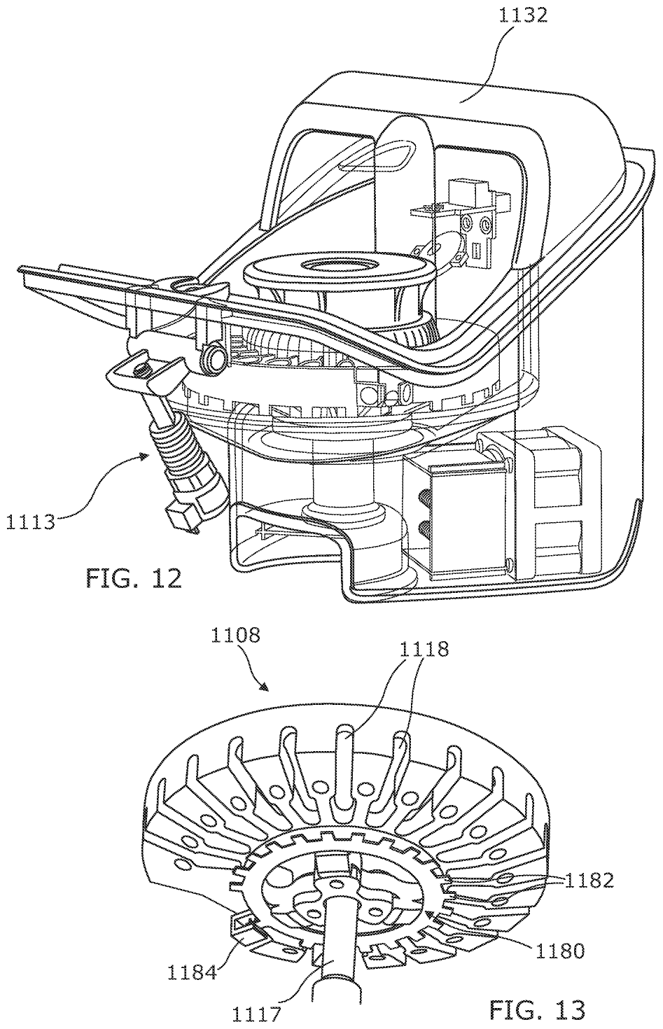

Further details of the configuration of the various components of the apparatus 1101, and the interactions between these components, will now be provided with reference to FIGS. 12 and 13.

Specifically, as may be seen in these figures, the motor 1110 is mounted to and supported by the base 1112a of the housing 1112; the motor 1110 also effectively forms a supporting base upon or to which the remaining components of the apparatus 1101 are mounted. The sample carousel 1108 is substantially circular in shape, and is mounted above and connected to the motor 1110 via a rotatable shaft 1117 that extends along a vertically-extending axis ‘X’ which passes through the centre of the sample carousel 1108. Rotational movement of the sample carousel 1108 about a central axis ‘X’ can thereby be driven by the motor 1110.

The sample carousel 1108 comprises a plurality of openings 1118 provided at radial intervals around the sample carousel 1108. According to the depicted embodiment, the openings 1118 are located radially about an outer portion of the sample carousel 1108 such that, when the fluidic device 1 correctly interfaces and engages with the sample carousel 1108 in correct orientation, the location of each one of the plurality of openings 1118 is aligned with and corresponds to the location of one of the plurality of fluid analysis chambers 12 provided within the fluidic device 1. As such, the fluid analysis chambers 12 can be located in any appropriate location of the fluidic device 1, for example, in an outer region thereof. As the skilled person will appreciate, the alignment between each opening 1118 and corresponding fluid analysis chamber 12 should be suitable to allow light from a light source (as described below) to pass through the opening 1118 into a respective fluid analysis chamber 12.

The optical apparatus 1102 comprises a light source 1122 and collimating optics (not shown), for example a laser diode; a light collector or light collection arrangement 1124; and at least one photodetector 1126. The light source 1122 emits light along an incident beam axis ‘Y’ and illuminates the sample portion(s) present in the fluid analysis chamber(s) 12 of the fluidic device 1. The light collector 1124 collects light scattered in a forward direction by bacteria (particles) within the sample, particularly light scattered between the angles of around +/−3 to +/−24 degrees from the incident beam axis Y; +/−4 to +/−20 degrees from the incident beam axis Y; and in some embodiments, light scattered between the angles of +4 and +16 degrees, and −4 and −16 degrees on either side of the incident beam axis Y (e.g. in a ring of particular radius about the light beam). In some embodiments, the light collected may be scattered between the angles of +5 and +16 degrees, and −5 and −16 degrees on either side of the incident beam axis Y. It will of course be appreciated by the skilled person that light scattered over even smaller angles (i.e. less than +/−3 or +/−4 degrees on either side of the incident beam axis) may also be collected; however this may undesirably increase the proportion of non-scattered incident light that is collected by the light collector 1124. The width of the incident light beam could be reduced to allow light scattered at even smaller angles to be collected without including too great a proportion of the non-scattered light; however, this will in turn result in illumination of a smaller amount of the sample, which will reduce the amount of scattered light produced. There is hence a balance to be maintained in this regard.

The collected scattered light is directed to the photodetector 1126 by the light collector 1124, where, for example, the intensity of the collected scattered light may be analysed to ascertain relative bacterial amount or concentration of the sample in the detection chamber at a given point in time as function of the amount of scattered light detected.

The various components of the optical apparatus 1102 are mounted to a support plate or structure 1128 to form an optical ‘tower’ that, in the depicted embodiment, extends substantially vertically upwards from, and is supported by, the motor 1110 or a housing 1110a thereof. However, it will be appreciated that the mounting of the optical ‘tower’ 1128 may be separate or de-coupled from the motor 1110 and its housing 1110a, so as to isolate the optical apparatus 1102 from any vibrations that may be generated by the motor 1110. In either case, this optical tower 1128 structure is therefore also substantially perpendicular to the plane in which the sample carousel 1108 and fluidic device 1 rest when in use. The incident beam axis ‘Y’ of the light emitted from the light source 1122 is therefore parallel to, but laterally offset from, the rotational axis ‘X’ of the sample carousel 1108 by a distance ‘d’.

The lateral offset ‘d’ between the rotational axis X and the incident beam axis Y corresponds substantially to the radial distance between (the centre of) the fluid analysis chambers 12 and the centre of the fluidic device 1. Conveniently, the distance ‘d’ may also be the same or substantially the same as the radial distance between the centre of the sample carousel 1108 to the openings 1118 provided within the platform. The support structure 1128 for the optical apparatus 1102 has a gap or cut-out 1130 provided in it which is located (somewhere in the vertical plane) between the light source 1122 and the light collection arrangement 1124, and in the plane of the sample carousel 1108; this cut-out 1130 is sized and located such that it is configured to receive a radially-outer portion of the sample carousel 1108 within it. Accordingly, this received portion of the sample carousel 1108 (and hence a corresponding portion of the engaged fluidic device 1 in use) may extend into the support structure 1128 and optical tower and thereby intersect with the incident beam axis Y of the light emitted from the light source 1122. Indeed, the sample carousel 1108, support structure 1128, optical apparatus 1102 and fluidic device 1 are designed and adapted such that, in use, light emitted by the light source 1122 passes through the one of the openings 1118 of the sample carousel 1108, and subsequently enters the corresponding fluid analysis chamber 12 which is aligned with the respective opening 1118, thereby enabling the sample portion contained within that fluid analysis chamber 12 to be illuminated and analysed.

As a result, when the fluidic device 1 is engaged with the sample carousel 1108, each of the fluid analysis chambers 12 of the fluidic device 1 are locatable in turn in the incident beam axis ‘Y’ via rotation by the motor 1110 of the fluidic device 1 through the beam path of the light from the light source 1122. Scattered light from the bacteria particles in the portion of the sample that is contained in each fluid analysis chamber 12 can therefore be collected and measured in turn by the optical apparatus 1102. In some embodiments, by ‘measured’ it is meant to quantitatively assess the amount of light/intensity of light that is scattered by bacteria in the sample; whereas in other embodiments a qualitative assessment of the relative amount of scatter caused by samples in different sample chambers may be performed.

In the depicted embodiment, the optical apparatus support structure 1128 comprises an upper (overhanging) cover portion 1132 which supports some of the components of the optical apparatus 1102—for example, the light collection arrangement 1124 and the photodetector 1126. The upper cover 1132 also provides the additional useful functionality of preventing non-scattered light traveling along the substantially vertical incident beam axis ‘Y’ from exiting the apparatus 1101, or from accidentally reaching the user of the apparatus 1101 (e.g. in the event that the lid 1112d of the housing 1112 were to be removed whilst the light source 1122 is emitting light). In addition, the optical housing 1112 protects the optical components from traces of sample the user may have left on the outer surface of the device 1 prior to insertion into the apparatus 1101.

As shown in FIG. 13, in embodiments of the present disclosure the sample carousel 1108 comprises an additional calibration ring or toothed wheel 1180 located on its underside and comprising a plurality of calibration features or teeth 1182. In the illustrated embodiment, the calibration features 1182 correspond to a plurality of radially extending spokes protruding from the calibration ring 1180 at intervals, and arranged such that each calibration feature 1182 is associated with a corresponding one of the plurality of openings 1118.

In use, when the fluidic device 1 is engaged with the sample carousel 1108, each calibration feature 1182 will therefore also be associated with a corresponding one of the plurality of fluid analysis chambers 12 in the sample container body 2. The apparatus 1101 further comprises a calibration reader 1184 located adjacent to the underside of the sample carousel 1108 and configured to interface with each of the calibration features 1182 in turn as the sample carousel 1108 is rotated by the driving shaft 1117 in use. Specifically, the calibration reader 1184 may comprise an optical arrangement that is configured to detect each calibration feature 1182 passing through or past it, for example, via detection of a decrease or loss in optical signal that is caused by the calibration feature 1182 passing through and temporarily breaking an optical beam path within the calibration reader 1184.

As the calibration features 1182 are each associated with one of the fluid analysis chambers 12, the calibration reader 1184 can be used to detect each calibration feature 1182 associated with each opening 1118 of the sample carousel 1108, and send a signal to a controller/processor of the device 1 to commence measurement of scattered light intensity a predetermined time period after detection of the calibration feature 1182, and for a predefined period of time sufficient to encompass the period wherein the analysis chamber 12 intercepts the light from the light source 1122 without impinging on the walls of the analysis chamber 12 (i.e. for an interval sufficient to obtain a reading or light scatter from the fluid within each analysis chamber 12). Beneficially, in this way, the light scatter measurement window is reset multiple times per revolution of the fluidic device 1 to ensure that the photodetector readings are appropriately in phase with the analysis chambers 12. It will be appreciated that the number of calibration features can be selected according to preferences: for example, there may be a calibration feature associated with every opening 1118 in the sample carousel 1108, or there may be one calibration feature associated with a predetermined group of openings 1118 (e.g. one calibration feature 1182 for every 2, 3, 4, 5 or 6 etc. openings 1118).

Alternatively, the calibration features 1182′ may take a different form. For example, the calibration features may take the form of ribs, fins or flags that are provided at intervals around the circumference of the sample carousel 1108. In this instance, the calibration reader 1184 may instead be installed and oriented such that the calibration features pass through the optical arrangement of the calibration reader 1184. Suitably, one calibration feature is associated with each opening 1118 of the sample carousel 1108 such that the passage of each calibration feature through the optical arrangement of the calibration reader 1184 may form a trigger for a reading or measurement of scattered light obtained from each corresponding analysis chamber 12. Beneficially, this helps to prevent the drift that occurs in the ‘window’ due to variation in motor speeds, as a specific indicator is associated with each opening 1118 and hence with each analysis chamber 12.

In some cases it is envisaged that the calibration reader 1184 (or a processor associated with the photodetector 1126) may be configured to calculate the time interval between adjacent calibration features 1182 passing through the reader 1184, and to compare those calculated intervals with the pre-determined intervals at which the intensity of collected scattered light is measured. If there is a discrepancy between the measured ‘calibration’ time intervals, and the pre-determined measurement time intervals and that discrepancy exceeds a predetermined time interval, the processor may then be configured to alter the measurement time intervals to align them with the ‘calibration’ time intervals. This ensures that the intensity measurements are taken when the fluid analysis chambers 12 are accurately aligned with the incident beam axis—i.e. when the light from the light source is incident substantially through the centre of the fluid analysis chamber 12. It also conserves processing power and time by only analysing light scatter measurements in appropriate time windows.

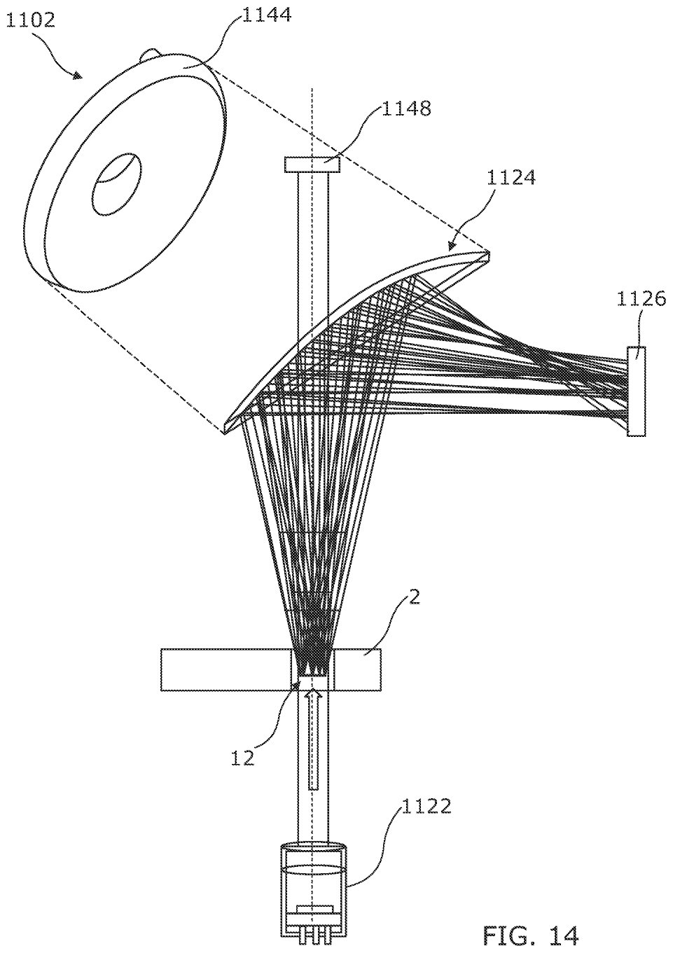

FIG. 14 illustrates details of an example arrangement of optical components in the optical apparatus 1102. In this arrangement, the light source 1122 corresponds to a laser module having a laser diode that is used to generate light at a specific wavelength (for example, red light in the wavelength range between 620 nm and 750 nm, and more particularly around 635 nm) for illuminating the sample portions contained in the fluid analysis chambers 12. It is noted that the above wavelengths have been envisaged for use in relation to the analysis of urine samples; however, depending on the nature of the sample that is to be analysed, the wavelength of light used may differ. For example, near infrared wavelengths (between about 650 nm and about 1,350 nm) could be utilised in relation to blood samples. The laser diode is connected to a signal generator (not shown) that is adapted to control a modulation frequency and phase of the laser output. The photodetector 1126 corresponds to a photodiode which is connected to a lock-in amplifier (also not shown); the lock-in amplifier is in turn connected to the signal generator for the laser diode. This enables the photodiode to isolate and filter out a specific received signal having a frequency and phase corresponding to the modulation frequency generated by the signal generator for the laser diode. This allows noise (light) signals at other frequencies (e.g. background noise, electrical noise) to be filtered out, thereby improving the signal-to-noise ratio obtainable using the optical apparatus 1102. These components may be controlled via one or more of the system's processors 1116, which may for example take the form of one or more Programmable Circuit Boards (PCB).

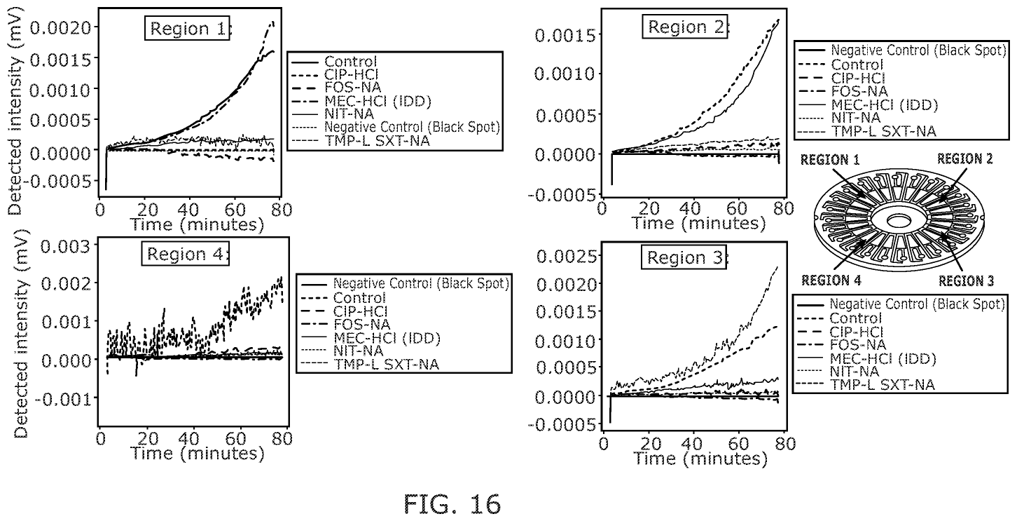

The light collector 1124 in this example comprises a reflector or reflective surface that, in the depicted embodiment, is mounted to the support structure 1128 so as to extend across the incident beam path. Specifically, the light collector 1124 of FIG. 14 corresponds to a curved concave elliptical mirror 1144 having an off-centre aperture, hole or opening 1146 provided within it. The mirror 1144 is mounted to the support structure 1128 such that the hole 1146 is aligned with the incident beam axis ‘Y’, thereby allowing non-scattered light exiting the fluid analysis chamber 12 and traveling along the beam axis Y to pass cleanly through the mirror 1144 substantially non-deflected; this non-scattered light is thereby prevented from reaching the photodetector 1126. Furthermore, the mirror 1144 is arranged at such an angle and is of such a size that the light scattered in the forward direction by the particles in the sample, and particularly the light scattered within the range of angles between about +4 and +16 degrees, and about −4 and −16 degrees of the incident beam axis Y, is reflected by the mirror 1144 and towards the photodetector 1126. In some other embodiments, the light reflected by the mirror 1144 towards the photodetector 1126 may be in the range of angles between about +3 and +24 degrees and about −3 and −24 degrees; between about +3 and +20 degrees and about −3 and −20 degrees; between about +5 and +20 degrees and about −5 and −20 degrees; or between about +5 and +16 degrees and about −5 and −16 degrees of the incident beam axis Y. In the arrangement of the depicted embodiment, concave, elliptical mirror 1144 reflects forward scattered light within the determined angles away from the incident beam axis Y (and in the particular, non-limiting, embodiment depicted, by substantially 90 degrees relative to the incident beam axis Y) to be concentrated onto/focused on the photodetector 1126. One or more of the system processors 1116 is associated with the photodetector 1126 and processes the detection signals generated by the photodetector 1126 to calculate the intensity of the scattered light detected. A graph or plot of the detector output (which corresponds to the measured scattered light intensity as a function of time) may be generated; examples of such graphs are shown in FIG. 16. This graph and/or the data used to generate it may in some embodiments be displayed to the user via the user interface 1115, for example as a substantially real-time indication of progress, at regular intervals, or as a final (summary) output once the analysis process for a given sample is complete.

As shown in FIG. 14, the system of this embodiment also comprises a second photodetector 1148, aligned with the incident beam axis ‘Y’, but located on the opposite side of the light collector 1124 from the sample and arranged to detect and measure the non-scattered light that passes through the hole 1146 in the mirror 1144. This second photodetector 1148 also corresponds to a photodiode that may be configured in substantially the same manner to that of the first (main) photodetector 1128—i.e. the second photodetector 1148 is connected to the signal generator of the light source 1122 via a lock-in amplifier to ensure that the second photodetector 1148 (and/or one of the processors 1116 that is associated with the photodetector 1148) is also able to filter out the desired laser signal frequency and phase from any noise signals. Provision of this additional second photodetector 1148 allows for a baseline measurement of the non-scattered laser light to be obtained, which may be compared with the scattered light intensity measured by the first (main) photodetector 1126. This allows, for example, anomalies in the illumination to be detected; the laser stability may also be assessed and taken into account during analyses. It will be appreciated that in any of the embodiments of the disclosure, a second photodetector 1148 may be omitted. In some such embodiments, a beam dump or other apparatus may be used to collect non-scattered light from the laser.

While the optical arrangement depicted in FIG. 14 is particularly beneficial in reducing the number of parts necessary to perform/implement the disclosure, other optical arrangements may also be possible. For example, the customised concave elliptical mirror 1144 of FIG. 14 may be replaced with a pair of reflective elements, for example, a first mirror that deflects forward scattered light onto a focusing lens or second concave mirror, which concentrates reflected light from the first mirror onto a photodetector 1126.

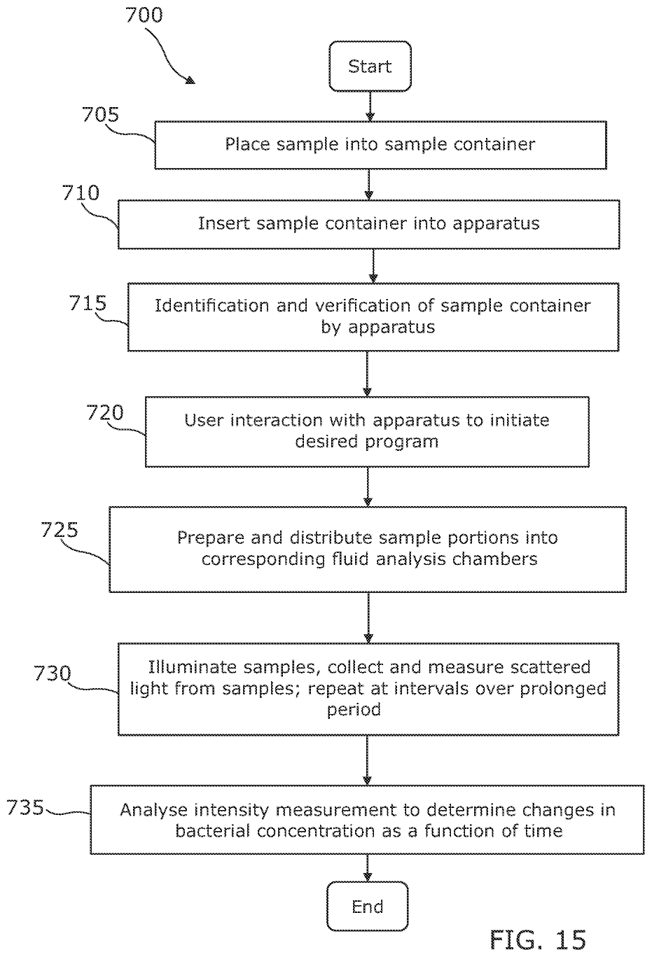

A method 700 of using the above-described apparatus 1101 will now be described with reference to FIG. 15.

To begin with, the clinical sample is placed securely in the fluidic device 1 by the user in Step 705, and the fluidic device 1 is then inserted into its appropriate location within the apparatus 1101 in Step 710. This involves correctly aligning the fluidic device 1 with the optical tower support structure 1128 (e.g. aligning the indent or cut-out segment or other surface feature 24 of the fluidic device 1 with the support structure 1128—whereby the cut-out segment 24 is shaped and sized to generally mirror the profile of the optical tower support structure 1128—or corresponding/complementary structure of the device 1101) and engaging the fluidic device 1 with the sample carousel 1108. In some embodiments, this process may be guided by the user interface 1115 (e.g. via a series of diagrams and corresponding written/spoken instructions). The lid 1112d of the device 1101 is then closed and the user interacts with the user interface 1115 in Step 720 in order to initiate the sequence of pre-programmed actions that are to be taken by the various components of the device in order to perform the desired sample analysis.

Prior to these pre-programmed actions being performed, or in fact as part of these actions, the apparatus 1101 may be configured to identify in Step 715 the fluidic device 1 and determine information relating to that specific fluidic device 1, based on data provided on the fluidic device 1 itself or on packaging thereof. In some cases, this information may be contained within or obtainable via a unique identification code provided on the fluidic device 1, which may include a unique identifier associated with the fluidic device 1 itself, a unique identifier associated with a particular batch of which the fluidic device 1 forms a part, and a use-by date for the contents of the fluidic device 1. This identification code may be provided in the form of an RFID tag or a barcode (e.g. a 2D barcode) that may be scanned by the apparatus 1101, either prior to the insertion of the fluidic device 1 (e.g. via a separate scanner associated with the apparatus 1101), or even after insertion of the fluidic device 1 (e.g. via a scanner integrated into the apparatus 1101). For example, an internal barcode scanner/reader 1159 is shown (in the illustrated device of FIG. 11) as being mounted to an internal wall of the device housing 1112. In this embodiment, the scanner 1159 is mounted at a particular angle such that it is directed towards an identifying RFID tag or barcode located on the sample container. For instance, the barcode or other means of identification may be located on an angled portion 25 of the fluidic device 1 (e.g. positioned adjacent the cut-out segment 24 of the fluidic device 1 so that it can be read by the scanner 1159 once the fluidic device 1 is inserted into the device 1101).

Additional information may also be provided as part of or in addition to the identification code, for example, details of the specific drugs provided within each of the fluid analysis chambers 12 of a given fluidic device 1, such that the analysis is performed with knowledge of the drugs that are being tested. Furthermore, details regarding software updates that may need to be implemented may also be included as part of the provided information; this enables the apparatus 1101 to easily and efficiently obtain information from the fluidic device 1 itself regarding the appropriate software updates and changes that may be required.

Additionally or alternatively, the unique identification code can be provided on the packaging of the fluidic device 1 (e.g. on a box containing one or a plurality of fluidic devices 1 of a particular batch), or may even be provided together with the packaging, for example in the form of a USB stick that is associated with the packaging and which has been pre-loaded with the relevant identification information. Advantageously, utilising the packaging or a separate USB stick to provide this information increases the storage space available to contain the data, thereby enabling more data to be provided within the identification code. In such a case, the device housing 1112 may be provided with a port to receive and interface with the USB stick. The apparatus 1101 may also be programmed to verify that the fluidic device 1 is one of an approved batch of containers that can be used with the apparatus 1101 (e.g. to identify any counterfeit or unauthorised sample containers and prevent them from being used with the apparatus 1101). In this regard, the fluidic device 1 may be provided with an identifying (anti-counterfeit) feature that is detectable by the apparatus 1101; this may be provided as part of, or in addition to, the unique identification code described above. The apparatus 1101 may be programmed to reject or refuse to process any fluidic devices 1 that do not include such a feature to avoid unreliable or misleading results being detected and reported to a user.

A first series of pre-programmed actions that is carried out by the apparatus 1101 in Step 725 is therefore to operate the motor 1110 to rotate at particular rotational frequencies, in certain predefined directions and for specific durations, in order to re-distribute portions of the clinical sample from the main fluid reservoir 4 of the fluidic device 1 into each of the plurality of fluid analysis chambers 12—i.e. to carry out Steps 510 to 530 of the method 500 illustrated in FIG. 10.

Once this process has been carried out and the various drug-dosed sample portions have been re-distributed into their respective fluid analysis chambers 12, the next series of pre-programmed actions taken by the apparatus 1101 involves the analysis of the samples in each fluid analysis chamber 12—i.e. the details of Step 535 in the method 500 of FIG. 10 will now be described. The motor 1110 is programmed to drive rotation of the sample carousel 1108 and its associated fluidic device 1 at a constant rotation rate (e.g. 100 rpm) over a prolonged period of time (e.g. over the course of around 30 to 90 minutes), such that a given point on the fluidic device 1, e.g. a particular fluid analysis chamber 12, carries out a full rotation approx. every 0.6 seconds. Accordingly, at a rotational speed of 100 rpm, each detection chamber 20 would pass through the incident beam axis Y at predetermined intervals (e.g. of around every 0.6 seconds). Each sample portion in its respective fluid analysis chamber 12 is therefore illuminated in turn (every predetermined time interval), and the scattered light is collected by the photodetector 1126 and can be processed/analysed at regular intervals over the course of an assay (e.g. a bacterial growth/antibiotic susceptibility assay). Given the frequency of measurements, in some instances, it is envisaged that a (weighted) rolling average of sample measurements may be used to process and combine the scattered light measurements obtained from each detection chamber 12. This would beneficially reduce the noise associated with each averaged sample measurement point (by the square root of the number of individual measurements combined to obtain the weighted average). For example, in some cases, it is envisaged that the rolling average could be applied over from 50 to 500 measurements (e.g. over 100 measurements, which equates to 60 seconds at the 100 rpm rotational rate envisaged). In some embodiments the rotational speed of the sample carousel 1108 (and fluidic device 1) is selected according to a pre-programmed/factory setting; and may be determined according to the processing speed of the device 1101, and/or the frequency of measurements that is desired. Therefore, the rotational speed of the fluidic device 1 during an assay may be faster or slower than 100 rpm (e.g. between 50 and 300 rpm). Similarly, the length of an assay may also be based on pre-programmed/factory settings, or may in some embodiments be set according to user-preferences. For example, the length of the assay may be determined by the type of bacteria and/or the antibiotics that are to be tested against the bacteria; and may be between about 20 minutes and 4 hours, such as between about 20 minutes and 2 hours, or between about 20 mins and 1.5 hour. In some preferred embodiments, the length of the assay is between about 20 minutes and 1 hour, or between about 30 minutes and 1 hour.

As has been briefly mentioned earlier in this document, the strength of signal generated by the main ‘signal’ photodiode 1126 as a result of the scattered light intensity measured, is correlated with the amount and/or concentration of (bacterial) particles within the sample being analysed/assayed. In other words, a larger/stronger signal corresponds to a greater amount of light scattering and, hence, a greater scattered light intensity, which in turn indicates a higher concentration of bacteria particles within the sample. Graphical representations of the detected signal (based on the scattered light intensity) over time can thus be used to visualise and/or calculate time-varying changes in bacterial amount and/or concentration in a sample, and thereby illustrate and ultimately determine the susceptibility of the bacteria within that sample to the type and concentration of drug with which that particular sample has been dosed.

Examples of such graphical representations are shown in FIG. 16, where the susceptibility of bacteria in a clinical sample to five different types of antibiotic drugs was tested. In this example, the fluidic device 1 was divided into 28 separate fluid analysis chambers 12 and associated channels for separating a clinical sample into the 28 fluid analysis chambers 12, such that up to 28 separate assays could be performed simultaneously. The 28 assays were divided into four regions—labeled Regions 1 to 4—and in each region five antibiotic susceptibility tests were carried out alongside one negative control (wherein the fluid analysis chamber was altered (e.g. rendered opaque) to prevent incident light from passing through) and one positive control (to follow uninhibited bacterial growth in the absence of any antibiotic). In this instance five different antibiotics were provided, respectively in each of five assay chambers of each region, so that bacterial susceptibility against each antibiotic could be tested in 4 repeats per fluidic device 1, with one such test in each of the four regions. In this way, the reproducibility of the assays around the fluidic device 1 could also be assessed. The fluidic device 1 was rotated at around 100 rpm and measurements of scattered light intensity collected from each fluid analysis chamber 12 were taken over the course of around 80 minutes.

As is evident from the graphs in FIG. 16, those fluid analysis chambers serving as the positive control exhibited generally exponential increase in detected scattered light intensity (and hence a corresponding exponential bacteria amount and/or concentration increase) over the course of the measurement period. This reflects the degree of increase in bacterial amount and/or concentration that would typically be expected (under the assay conditions) if no drugs or other inhibitors were present, and the bacteria were able to grow and replicate normally in a solution containing an appropriate concentration of growth medium. Meanwhile, those fluid analysis chambers serving as the negative control showed minimal detected intensity over the entire measurement period, as would also be expected. Of the five fluid analysis chambers in each quadrant containing the various antibiotics, four exhibited changes in detected intensity that indicated a decrease in bacterial amount and/or concentration (relative to the positive control) as a result of the action of the antibiotics—i.e. a curve having a lower or negative gradient relative to the positive control curve, but still (at least initially) having values above the negative control line. Of the various drug-dosed samples, the one which exhibits the greatest decrease in the measured intensity of light scattering over time, compared with the positive control sample, would therefore (in theory) correspond to the sample that has been dosed with the specific type and/or concentration of antibiotic that the bacterial strain present in the sample is most susceptible to. It can therefore be easily determined, over the course of a relatively short period of time, which antibiotic and at which concentration will likely be most effective in treating the patient from which the clinical sample was obtained.

It is of course possible (and in fact quite likely) that multiple different antibiotics may be determined to be ones to which the bacteria in the sample may be susceptible. Various different approaches for determining the most appropriate antibiotic to be used for treatment have therefore been considered. For example, the susceptibility results may be presented to the user in real-time, with the ability to terminate the analysis at any point after at least one antibiotic has been ascertained to be effective. This may however not necessarily be the most appropriate antibiotic to administer; for example, if the response of the bacterial culture changes over a slightly longer time period, or where one antibiotic requires a longer incubation time initially to take effect. Alternatively, another approach may be to limit the time for the test to be carried out (to e.g. 30 mins, 45 mins or 1 hour) and to present the results to the user after that time: this may mean that multiple antibiotics (or even none) and/or multiple dosage levels may be considered for administration to a subject. Another option is to only present results after a certain number of antibiotics have been deemed effective. This will of course mean that the timescale required for the test will vary. Of course, in embodiments of the disclosure a combination of these approaches may be adopted.

Many modifications may be made to the above examples without departing from the scope of the present disclosure as defined in the accompanying claims.

For example, the drugs need not be provided within the fluid analysis chambers 12 but could instead be located at a different portion of the fluidic systems 6, for example, within the second channel arm 32d of the second fluidic channel 32.

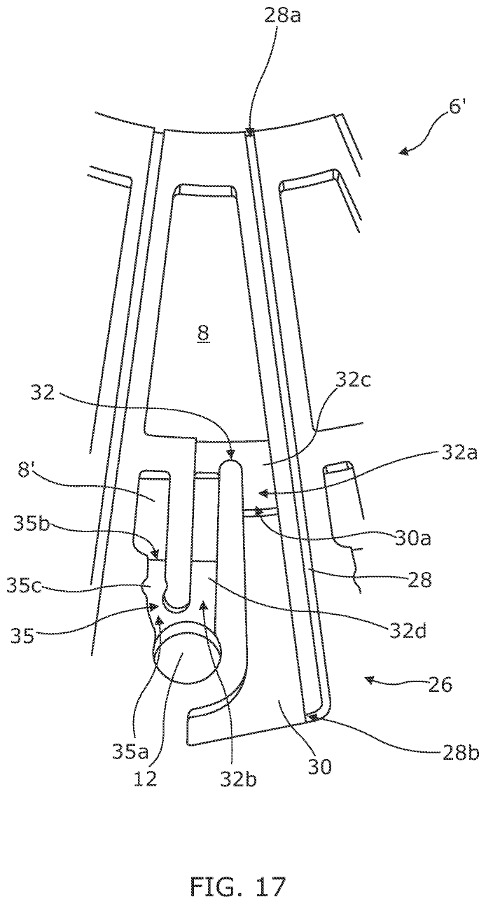

Additionally, or alternatively, a second valve mechanism comprising a chamber of compressed stored gas may be provided at a position in the flow path of each fluidics system 6 after the fluid analysis chamber 12, so as to allow more effective mixing of the sample with the drug (via a ‘sloshing’ action back and forth between the two valves during reciprocal rotation) where a particular drug is, perhaps, not rapidly dissolved in the fluid sample, as shown in FIG. 17.

FIG. 17 shows an alternative arrangement of a fluidics system 6′ for use in accordance with embodiments of the disclosure. The fluidics system 6′ is arranged generally in the same way as the fluidics system 6 of FIGS. 2, 2A in the region between the main fluid reservoir 4 and the analysis chamber 12. Thus, the fluidics system 6′ comprises a fluidic channel arrangement 26 comprising a first entry fluidic channel 28 having an entry port 28a at its radially innermost extent that is in communication with the main fluid reservoir 4, and an exit port 28b at its radially outermost extent that is in communication with a separation or clarification chamber 30. In the illustrated embodiment, the exit port 28b is located towards the radially outermost extent of the fluidics system 6; although, as described in relation to FIGS. 2C and 2D, in various embodiments the fluid analysis chamber 12 may be the radially outermost fluid chamber. As before, the separation chamber 30 takes the form of a well formed in the substrate of the radially outer portion 18 of the container body 2 and is configured to enable the separation of unwanted particles/impurities from the rest of the fluid sample. The exit port 28b of the first fluidic channel 28 is preferably connected towards the outermost wall portion (i.e. near the radial ‘base’) of the separation chamber well 30. The fluidic channel arrangement 26 further comprises a second fluidic channel 32 having an entry port 32a in communication with the separation chamber 30, and an exit port 32b in communication with the fluid analysis chamber 12. A weir (or step) 30a is located between the separation chamber 30 and the entry port 32a of the second fluidic channel 32 which improves the separation/clarification functionality provided by the separation chamber 30. The second fluidic channel 32 is substantially U-shaped and comprises first and second channel arms 32c, 32d arranged to provide fluid flow paths in generally antiparallel directions either side of the first valve mechanism/air spring 8. Thus, the first channel arm 32c extends roughly (anti)parallel to the first fluidic channel 28, such that the fluid sample flows out of the separation chamber 30 and along the first channel arm 32c in a radially inwards direction and the second channel arm 32d extends roughly (anti)parallel to the first channel arm 32c and enables the fluid sample to reverse its flow direction such that the fluid sample travels in a radially outwards direction towards the fluid analysis chamber 12. The two channel arms 32c, 32d are in fluid communication with one another, at their radially innermost extents, via the first air spring 8. The compressed gas can thus be configured to provide an opposing pressure so as to prevent fluid flow between the two channel arms 32c, 32d by exerting gas pressure in opposition to the centrifugal force applied to the fluid sample via rotation of the fluidic device 1. In accordance with this embodiment, a third fluidic channel 35 is provided in communication with the analysis chamber 12 and connecting the analysis chamber 12 with a second valve mechanism or air spring 8′. The third fluidic channel 35 has an entry port 35a communicating with the analysis chamber 12 and an exit port 35b communicating with the second valve mechanism 8′; the third fluidic channel 35 is arranged generally (anti)parallel with the second channel arm 32d of the second fluidic channel 32, such that the second valve mechanism 8′ is arranged radially inwards of the analysis chamber 12. In some embodiments, an enlarged region 35c of the third fluidic channel 35 may be provided within which a drug/antibiotic may be placed instead of within the analysis chamber 12.

Conveniently, according to embodiments of this aspect of the disclosure, in use, once sample fluid has filled the analysis chamber 12, the speed of rotation of the fluidic device 1 may be increased to force the liquid sample towards the second valve mechanism 8′ along fluidic channel 35. Once the liquid sample has reached as far as the region 35c of the fluidic channel (which in some embodiments may not be an enlarged region of the fluidic channel, but may simply correspond to the region in which drug is deposited), the sample can begin to dissolve the drug/antibiotic. By reducing the rotational speed of the fluidic device 1, the pressure in the second valve mechanism 8′ overcomes the centrifugal force of the liquid sample and the sample is pushed back towards the analysis chamber 12 Thus by reciprocally increasing and decreasing the rotation speed, the liquid sample can be made to flow (slosh) backwards and forwards along the fluidic channel 35 across the region 35c so that the antibiotic is dissolved efficiently and effectively. These embodiments may be particularly beneficial for use in combination with drugs that may not be so readily dissolved in the liquid sample, because mixing between the sample and drug may be improved. Embodiments of the fluidics system 6′ may generally be used according to the rotational speed pattern already described in respect of the fluidics system 6 (above).

Furthermore, it is noted that the design of the fluidic device 1 may be altered to vary the optical path length of light passing through the fluid analysis chamber 12 by varying the depth of the chamber well. Increasing the optical path length will increase the signal: the light will pass through more sample and interact with more bacteria particles in the process. Example path lengths that may be considered are between 3 and 10 mm or between 4 and 8 mm (e.g. well depths of 4, 5, 6 or 7 mm); altering the optical path length will also involve altering the sizes of the other features in the fluidic system 6, such as the clarification chamber 30 and the air spring 8 or springs 8; 8′. As described in relation to earlier embodiments, the volume of the second air spring/valve mechanism 8′ may be selected according to preference (e.g. based on the volume of the analysis chamber 12 and/or the desired speed of rotation of the device). In particular embodiments, the volume of the second air spring 8′ may be between about 10 and 50 μl.

Other mechanisms for improving the signal to noise ratio involve ‘masking’ of the edges of the fluid analysis chambers 12, for example by securing a thin film or sheet of plastic or other thin material to the base of the fluidic device 1 to prevent light from entering or interacting with other portions of the fluidic device 1—for example, the openings 1118 in the sample carousel 1108 may be smaller in diameter than the diameter of the fluid analysis chambers 12.

1. A fluidic device configured to drive movement of fluid under centrifugal force, the fluidic device comprising:
a central region about a central rotational axis of the device and a peripheral region extending radially outwards from the central region;
a fluid reservoir provided in the central region of the device for receiving a fluid sample, the fluid reservoir in communication with at least one fluidic system, the at least one fluidic system extending radially outwards from the fluid reservoir into the peripheral region of the device; the at least one fluidic system comprising:
a fluid analysis chamber configured to retain a portion of a fluid sample for analysis;
a fluidic channel arrangement configured to enable fluid communication between the fluid reservoir and the fluid analysis chamber, wherein movement of the fluid sample through the fluidic channel arrangement is driven by centrifugal force arising from rotational motion of the device about the central rotational axis; and
a first valve mechanism configured to prevent fluid flow through a portion of the fluidic channel arrangement when the speed of rotation of the device is less than a first predetermined value, wherein the first valve mechanism is arranged between the fluid reservoir and the analysis chamber.

2. The fluidic device of claim 1, wherein the fluidic channel arrangement comprises:
a separation chamber configured to remove unwanted particles from the fluid sample prior to the fluid sample entering the analysis chamber; and
a first fluidic channel extending radially outwardly from the fluid reservoir to the separation chamber and communicating with the separation chamber through a wall in a radially outer region of the separation chamber.

3. The fluidic device of claim 2, wherein the separation chamber has a depth (d) defining the height between a base of the separation chamber and the top of the separation chamber, and the first fluidic channel is arranged to communicate with the separation chamber at or proximate the base of the separation chamber.

4. The fluidic device of claim 2, wherein the fluidic channel arrangement comprises:
a second fluidic channel configured for fluid communication between the separation chamber and the fluid analysis chamber,
and wherein the first valve mechanism is located in the flow path of the second fluidic channel between the separation chamber and the analysis chamber.

5. The fluidic device of claim 4, wherein the second fluidic channel comprises a pair of channel arms configured to enable fluid flow in substantially antiparallel directions, and wherein the first valve mechanism is located in the flow path between the two channel arms.

6. The fluidic device of claim 4, wherein the second fluidic channel comprises a first channel arm for fluid communication between the separation chamber and the first valve mechanism, the first channel arm extending radially inwardly from the separation chamber to the first valve mechanism and communicating with the separation chamber through a wall in a radially inner region of the separation chamber.

7. The fluidic device of claim 4, wherein the second fluidic channel comprises a second channel arm for fluid communication between the first valve mechanism and the analysis chamber, the second channel arm extending radially outwardly from the first valve mechanism to the analysis chamber.

8. The fluidic device of claim 4, wherein:
the second fluidic channel comprises a pair of channel arms configured to enable fluid flow in substantially antiparallel directions, and wherein the first valve mechanism is located in the flow path between the two channel arms; and
the internal corners of the channel arms are rounded, in use to reduce wicking of fluid along the channels in a direction counter to centrifugal forces acting on the fluid.

9. The fluidic device of claim 1, wherein the first valve mechanism is located radially inwardly of the separation chamber and/or the fluid analysis chamber.

10. The fluidic device of claim 1, wherein the first valve mechanism defines a chamber for receiving a predetermined quantity of gas, the chamber having maximum dimensions in x, y and z axes, wherein the x axis defines a radial direction, the y axis defines a direction perpendicular to the x axis in a radial plane, and the z axis defines a direction perpendicular to both the x and y axes parallel to the axis of rotation, and wherein the first valve mechanism has a largest dimension in the z axis.

11. The fluidic device of claim 1, wherein the first valve mechanism is arranged circumferentially around and adjacent the fluid reservoir.

12. The fluidic device of claim 2, wherein the fluid analysis chamber is arranged radially outwards of the separation chamber.

13. The fluidic device of claim 1, wherein the fluid analysis chamber is cylindrical having a substantially circular cross section in an axial plane of the device.

14. The fluidic device of claim 1, wherein one or more of the fluidics systems contains in a region thereof at least one drug in a form suitable for dissolution in the fluid sample.

15. The fluidic device of claim 1, wherein the fluidic channel arrangement further comprises a third fluidic channel, the third fluidic channel arranged to extend between the fluid analysis chamber and a second valve mechanism, and wherein the second valve mechanism is located radially inwardly of the analysis chamber.

16. The fluidic device of claim 1, wherein at least one fluidics system contains at least one drug to be assayed against the fluid sample, wherein the drug is provided in the fluid analysis chamber, in a first drug retention chamber located between the first valve mechanism and the fluid analysis chamber, or in a second drug retention chamber located between the second valve mechanism and the fluid analysis chamber.

17-18. (canceled)

19. The fluidic device of claim 1, further comprising a bacterial growth media configured to promote growth of bacteria potentially present in the fluid sample when mixed with the fluid sample; the growth media provided in the fluid reservoir or in a growth media compartment that is in fluid communication with the fluid reservoir.

20-21. (canceled)

22. The fluidic device of claim 1, the central region of the fluidic device comprises a sample receiving well for receiving a fluid sample, and wherein the sample receiving well is communicable with the fluid reservoir via a growth media compartment containing a growth media and a filter element arranged, in use, to filter the mixture of fluid sample and growth media before it enters the fluid reservoir.

23-36. (canceled)

37. The fluidic device of claim 1, which comprises an antibiotic sensitivity panel comprising a plurality of antibiotics, wherein the plurality of antibiotics are in amounts selected from one or more of the antibiotic amounts disclosed in Tables 1 or 2 or Table 3.

38. (canceled)

39. An apparatus comprising:
a fluidic device comprising:
a central region about a central rotational axis of the device and a peripheral region extending radially outwards from the central region;
a fluid reservoir provided in the central region of the device for receiving a fluid sample, the fluid reservoir in communication with at least one fluidic system, the at least one fluidic system extending radially outwards from the fluid reservoir into the peripheral region of the device; the or each at least one fluidic system comprising:
a fluid analysis chamber configured to retain a portion of a fluid sample for analysis;
a fluidic channel arrangement configured to enable fluid communication between the fluid reservoir and the fluid analysis chamber, wherein movement of the fluid sample through the fluidic channel arrangement is driven by centrifugal force arising from rotational motion of the device about the central rotational axis; and
a first valve mechanism configured to prevent fluid flow through a portion of the fluidic channel arrangement when the speed of rotation of the device is less than a first predetermined value, wherein the first valve mechanism is arranged between the fluid reservoir and the analysis chamber
a driving mechanism for driving rotational motion of the fluidic device about the rotational axis of the fluidic device; and
a controller executing machine readable code to cause the driving mechanism to control flow of the fluid sample from the fluid reservoir to the or each analysis chamber.

40-43. (canceled)

44. A method of moving a fluid sample from a fluid reservoir through a fluidic system formed in a fluidic device, the fluidic system comprising a fluid analysis chamber, and a fluidic channel arrangement configured to enable fluid communication between the fluid reservoir and the fluid analysis chamber, the method comprising:
rotating, by a driving mechanism, the fluidic device about a rotational axis at a first rotational speed and for a first duration to generate a first centrifugal force sufficient to drive flow of the fluid sample from the fluid reservoir into a first portion of the fluidic channel arrangement;
preventing, by a valve mechanism, onward flow of the fluid sample from the first portion of the fluidic channel arrangement into a second portion of the fluidic channel arrangement via pressure exerted by the valve mechanism in opposition to the first centrifugal force; and
rotating, by the driving mechanism, the fluidic device about the rotational axis at a second higher rotational speed and for a second duration to generate a second centrifugal force sufficient to overcome the pressure of the valve mechanism and drive flow of the fluid sample into the second portion of the fluidic channel arrangement and thereby into the fluid analysis chamber.
